(19) United States
(12) Patent Application Publication
(10) Pub. No.: US 2010/0323270 A1
(43) Pub. Date: Dec. 23, 2010

(54) FUEL CELL

(76) Inventors: Kazunori Shibata, Mishima-shi (JP); Masaaki Kondo, Owariasahi-shi (JP); Tomohiro Ogawa, Susono-shi (JP); Sogo Goto, Nishikamo-gun (JP); Takashi Kajiwara, Gotenba-shi (JP); Tsutomu Shirakawa, Toyota-shi (JP); Yuichi Yagami, Gotenba-shi (JP)

Correspondence Address: KENYON & KENYON LLP, 1500 K STREET N.W., SUITE 700, WASHINGTON, DC, 20005, US

(21) Appl. No.: 12/528,403

(22) PCT Filed: Feb. 27, 2008
(86) PCT No.: PCT/IB08/00424

§ 371 Date: Aug. 24, 2009

(30) Foreign Application Priority Data
Feb. 28, 2007 (JP) 2007-048513
Jul. 18, 2007 (JP) 2007-186618

(51) Int. Cl. H01M 8/10

(52) U.S. Cl. 429/480

(57) ABSTRACT

A fuel cell includes: an anode-forming layer that is provided on an outer side of one surface of an electrolyte membrane and that includes an anode; a cathode provided on an outer side of another surface of the electrolyte membrane; a partition wall portion that is formed in the anode-forming layer in the thickness direction thereof, and that divides at least a surface of the anode-forming layer remote from the electrolyte membrane into blocks, and that restrains movement of a gas between adjacent blocks; and a gas introduction portion which has a gas passage portion that allows the fuel gas to pass through and which introduces the fuel gas, via the gas passage portion, into the blocks divided by the partition wall portion.

### BACKGROUND OF THE INVENTION

1. Field of the Invention

The invention relates to a fuel cell.

2. Description of the Related Art

Fuel cells that generate power through electrochemical reactions between hydrogen and oxygen have been drawing attention as an energy source. Such a fuel cell generally has a membrane-electrode assembly (hereinafter, referred to as “MEA”) in which an anode is formed on one side surface of an electrode membrane and a cathode is formed on the other side surface thereof. In this fuel cell, a channel-forming member that forms a fuel gas supply channel is disposed on the anode (see Japanese Patent Application Publication No. 2004-6104 (JP-A-2004-6104)). Incidentally, the channel-forming member often used is an electroconductive porous body or the like. Besides, the anode or the cathode sometimes has a gas diffusion layer as well as a catalyst layer.

Generally, the oxidizing gas used in fuel cells is air, or a mixture gas of air and oxygen, etc. In such a case, nitrogen or the like in the air may sometimes leak from a cathode side to an anode side. In association with this, there is a possibility that the nitrogen or the like leaking from the cathode side (hereinafter, also referred to as leak gas) may reside in a fuel gas supply channel on the anode side. If such a leak gas thus resides in the fuel gas supply channel, there is a possibility that the fuel gas may not be supplied in a dispersed fashion to the anode (anode surface) and therefore lack of supply of the fuel gas may locally occur in some portions of the anode and the power generation in those portions may be restrained. In consequence, there is a possibility that the power generation efficiency of the fuel cell as a whole may decline.

In particular, the fuel cells of the anode dead-end operation type (that operates in, e.g., a mode in which substantially the entire amount of the fuel gas supplied to the fuel gas supply channel is consumed on the anode to generate power) are likely to experience the aforementioned problem. Besides, the aforementioned problem is not limited to the case where the leak gas resides, but can also occur in the case where a substance other than hydrogen that has mixed in the fuel gas or the like resides.

### SUMMARY OF THE INVENTION

The invention provides a technology for fuel cells that is capable of supplying the fuel gas to the anode in a dispersed fashion.

The invention has been accomplished in order to solve at least a portion of the aforementioned task, and can be realized in the following forms or applications.

An aspect of the invention relates to a fuel cell that includes: an anode-forming layer that is provided on an outer side of one surface of an electrolyte membrane and that includes an anode; a cathode provided on an outer side of another surface of the electrolyte membrane; a partition wall portion that is formed in the anode-forming layer in a thickness direction thereof, and that divides at least a surface of the anode-forming layer remote from the electrolyte membrane into a plurality of blocks, and that restrains movement of a gas between adjacent ones of the blocks; and a gas introduction portion which has a gas passage portion that allows the fuel gas to pass through, and which introduces the fuel gas, via the gas passage portion, into the blocks divided by the partition wall portion.

According to the fuel cell constructed as described above, the fuel gas can be supplied to the anode in the fuel cell in a dispersed fashion.

In the fuel cell of the foregoing aspect, the divided blocks may be arranged so that one block corresponds to one gas passage portion.

This construction makes it possible to restrain an impurity, such as a leak gas or the like, from locally residing in a block.

In the fuel cell of the foregoing aspect, the divided blocks may be formed in a honeycomb fashion. Incidentally, the blocks may be fOrmed to have a honeycomb fashion when viewed from the thickness direction of the anode.

With this construction, the fuel gas can easily spread to the corners of each block.

The fuel cell of the foregoing aspect may further include an oxidizing gas channel-forming portion that is provided on an outer side of the cathode and that forms an oxidizing gas supply channel for supplying an oxidizing gas in a direction along a surface of the cathode. As for the divided blocks, a block that corresponds to an upstream side in a flowing direction of the oxidizing gas that flows in the oxidizing gas supply channel may have a smaller volume than a block that corresponds to a downstream side in the flowing direction.

With this construction, large amounts of the fuel gas can be supplied to portions of the anode in which the amount of generated current is large, and therefore the power generation efficiency of the fuel cell can be improved.

The fuel cell of the foregoing aspect may further include an oxidizing gas channel-forming portion that is provided on an outer side of the cathode and that forms an oxidizing gas supply channel for supplying an oxidizing gas in a direction along a surface of the cathode. As for the divided blocks, a block that corresponds to a downstream side in a flowing direction of the oxidizing gas that flows in the oxidizing gas supply channel may have a greater gas permeability than a block that corresponds to an upstream side in the flowing direction.

With this construction, the decrease in the amount of the fuel gas supplied can be restrained in a portion of the anode that corresponds to the downstream side in the flowing direction of the oxidizing gas. Accordingly, the power generation efficiency in that portion heightens, so that the power generation efficiency of the fuel cell can be improved.

In the fuel cell of the foregoing aspect, the partition wall portion may be formed so that each block has a dome shape whose top portion faces in a direction toward an outer side of the anode, that is, a direction away from a side of the anode where the electrolyte membrane is located. Incidentally, the dome shape is a concept that comprehensively includes shapes whose section gradually lessens or enlarges. Besides, the dome shape herein is not limited to a shape whose top portion is formed to be roundish.

With this construction, the fuel gas introduced into each block easily diffuses in the block along the wall surface of the partition wall portion. Therefore, the residence of an impurity, such as the leak gas or the like, in the blocks becomes less likely, and the power generation efficiency of the fuel cell can be improved.

In the fuel cell of the foregoing aspect, the partition wall portion may be formed so as to be thinner at a side of the anode-forming layer that is relatively close to the electrolyte membrane than at a side of the anode-forming layer that is relatively remote from the electrolyte membrane.

With this construction, the catalyst layer-contacting area in each block becomes larger, so that the fuel gas diffusing in each block can be supplied to the catalyst layer in a larger amount. As a result, the power generation efficiency of the fuel cell will improve.

In the fuel cell of the foregoing aspect, the anode-forming layer may include a catalyst layer provided on an outer side of one surface of the electrolyte membrane, and a gas diffusion layer provided on an outer side of the catalyst layer, and the partition wall portion may be formed at least in the gas diffusion layer.

With this construction, the fuel gas can be supplied to the catalyst layer in a dispersed fashion.

In the fuel cell of the foregoing aspect, the partition wall portion may be formed in the gas diffusion layer without contacting the catalyst layer.

This construction will prevent the partition wall portion from damaging the catalyst layer.

In the fuel cell of the foregoing aspect, the gas introduction portion may be an electroconductive sheet portion having a sheet shape and being gas-impermeable which is provided on an outer side of the anode-forming layer, and the gas passage portion may be a plurality of penetration holes that are arranged in a dispersed fashion along a sheet plane of the electroconductive sheet portion, and the fuel cell may further include a fuel gas channel-forming portion that is provided on an outer side of the electroconductive sheet portion and that forms a fuel gas supply channel for supplying the fuel gas in a direction along a plane of the electroconductive sheet portion.

This construction will restrain an impurity, such as the leak gas or the like, from entering the fuel gas supply channel from the anode-forming layer side, and will restrain an impurity, such as the leak gas or the like, from residing in the fuel gas supply channel. As a result, the fuel gas can be supplied to the anode in a dispersed fashion.

In the fuel cell of the foregoing aspect, the anode may be lower in gas permeability than the fuel gas supply channel that is formed by the fuel gas channel-forming portion.

With this construction, the diffusion of the fuel gas supplied through the penetration holes of the electroconductive sheet can be promoted in each block in the anode.

In the fuel cell of the foregoing aspect, the penetration holes provided in the electroconductive sheet portion may be inclined with respect to a thickness direction of the electroconductive sheet portion.

With this construction, the fuel gas introduced into the blocks through the penetration holes easily diffuses in the individual blocks. Therefore, the residence of the leak gas in the blocks becomes less likely, and the power generation efficiency of the fuel cell can be improved.

In the fuel cell of the foregoing aspect, the gas introduction portion may be a pipe-shape member through whose interior the fuel gas passes, and the gas passage portion may be a plurality of penetration holes that are arranged in a dispersed fashion in the pipe-shape member.

This construction will lessen the variation of the amount of the fuel gas supplied to the anode.

In the fuel cell of the foregoing aspect, the gas introduction portion may be a pipe-shape member through whose interior the fuel gas passes, and the gas passage portion of the gas introduction portion may be an opening portion that is provided in an end portion of the pipe-shape member.

This construction will lessen the variation of the amount of the fuel gas supplied to the anode.

In the fuel cell of the foregoing aspect, substantially an entire amount of the fuel gas supplied to each block may be consumed on the anode.

In the fuel cell as described above, particularly, the provision of the foregoing constructions of the fuel cell makes it possible to restrain the residence of an inert gas, such as the leak gas or the like, and supply the fuel gas to the anode in a dispersed fashion.

In the fuel cell of the foregoing aspect, an anode side of the fuel cell may have a closed structure in which the fuel gas supplied to the anode is not discharged to outside.

In the fuel cell as described above, particularly, the provision of the foregoing constructions of the fuel cell makes it possible to restrain the residence of an inert gas, such as the leak gas, and supply the fuel gas to the anode in a dispersed fashion.

### BRIEF DESCRIPTION OF THE DRAWINGS

The foregoing and further objects, features and advantages of the invention will become apparent from the following description of embodiments with reference to the accompanying drawings, wherein like numerals are used to represent like elements and wherein:

FIGS. 1A and 1B are illustrative diagrams of a fuel cell system 1000 and a fuel cell 100;

FIG. 2 is a side view of the fuel cell 100;

FIG. 3 is a front view of a seal-integrated power generation assembly 200 (a view taken from the right side of the seal-integrated power generation assembly 200 in FIG. 2);

FIG. 4 is a sectional view showing a portion of a section of the seal-integrated power generation assembly 200 taken on line IV-IV in FIG. 3;

FIGS. 5A and 5B are front views of an electroconductive sheet 860 and an anode-side diffusion layer 820B;

FIG. 6 is an illustrative diagram showing a shape of a cathode plate 400 of a separator 600;

FIG. 7 is an illustrative diagram showing a shape of an anode plate 300 of the separator 600;

FIG. 8 is an illustrative diagram showing a shape of an intermediate plate 500 of the separator 600;

FIG. 9 is a front view of the separator 600;

FIGS. 10A and 10B are illustrative diagrams showing the flows of reactant gases within the fuel cell 100 of an embodiment of the invention;

FIG. 11 is an enlarged view of an X region shown in FIG. 10B;

FIG. 12 is a diagram of a fuel cell as a comparative example, showing how the fuel gas diffuses in an anode-side diffusion layer 820B that does not have a partition wall portion 825;

FIG. 13 is a front view of an anode-side diffusion layer 820B in a fuel cell 100A in accordance with a second embodiment of the invention;

FIGS. 14A and 14B are front views of an electroconductive sheet 860A and an anode-side diffusion layer 820B in a fuel cell 100B in accordance with a third embodiment of the invention;

FIG. 15 is a front view of an anode-side diffusion layer 820B1 in a fuel cell 100C in accordance with a fourth embodiment of the invention;

FIG. 16 is an illustrative diagram showing the flows of the fuel gas on the anode side in a fuel cell 100D of a fifth embodiment of the invention;

FIG. 17 is an illustrative diagram showing the flows of the fuel gas on the anode side in a fuel cell 100E of a sixth embodiment of the invention;

FIG. 18 is an illustrative diagram showing the flows of the fuel gas on the anode side in a fuel cell 100F in accordance with a seventh embodiment of the invention;

FIG. 19 is a diagram am for describing partition wall portions 825E of a fuel cell in Modification 1;

FIG. 20 is an illustrative diagram showing a construction of a first modification of a shower channel;

FIG. 21 is an illustrative diagram illustrating functions of a dispersion plate 2100;

FIG. 22 is an illustrative diagram showing a construction of a second modification of the shower channel;

FIG. 23 is an illustrative diagram showing a dispersion plate 2102 that is constructed by using a pressed metal as a third modification of the shower channel;

FIG. 24 is a schematic diagram schematically showing a section taken on line XXIV-XXIV in FIG. 23;

FIG. 25 is an illustrative diagram showing a construction in which channels are formed within a dispersion plate 2014hm as a fourth modification of the shower channel;

FIG. 26 is an illustrative diagram showing a construction in which a dispersion plate 2014hp is formed by using pipes as a fifth modification of the shower channel;

FIG. 27 is a schematic diagram showing a construction example in which a so-called branch channel-type fuel gas supply channel is employed;

FIGS. 28A and 28B are schematic diagrams showing construction examples of channel-forming members that each have a serpentine channel that has a zigzag channel shape;

FIG. 29 is an illustrative diagram schematically showing an internal construction of a circulation path-type fuel cell 6000 as a modification of the fuel gas supply channel;

FIG. 30 is an illustrative diagram illustrating the flows of the fuel gas as a first modification of the fuel gas supply configuration;

FIG. 31 is an illustrative diagram illustrating the flows of the fuel gas in a second modification of the fuel gas supply configuration;

FIG. 32 is a diagram showing a construction example of the fuel cell of the invention (example No. 1 of the kind); and

FIG. 33 is a diagram showing a construction example of the fuel cell of the invention (example No. 2 of the kind).

### DETAILED DESCRIPTION OF THE EMBODIMENTS

Hereinafter, fuel cells in accordance with the invention will be described on the basis of embodiments with reference to the drawings.

### A. First Embodiment

A1. Construction of Fuel Cell System 1000

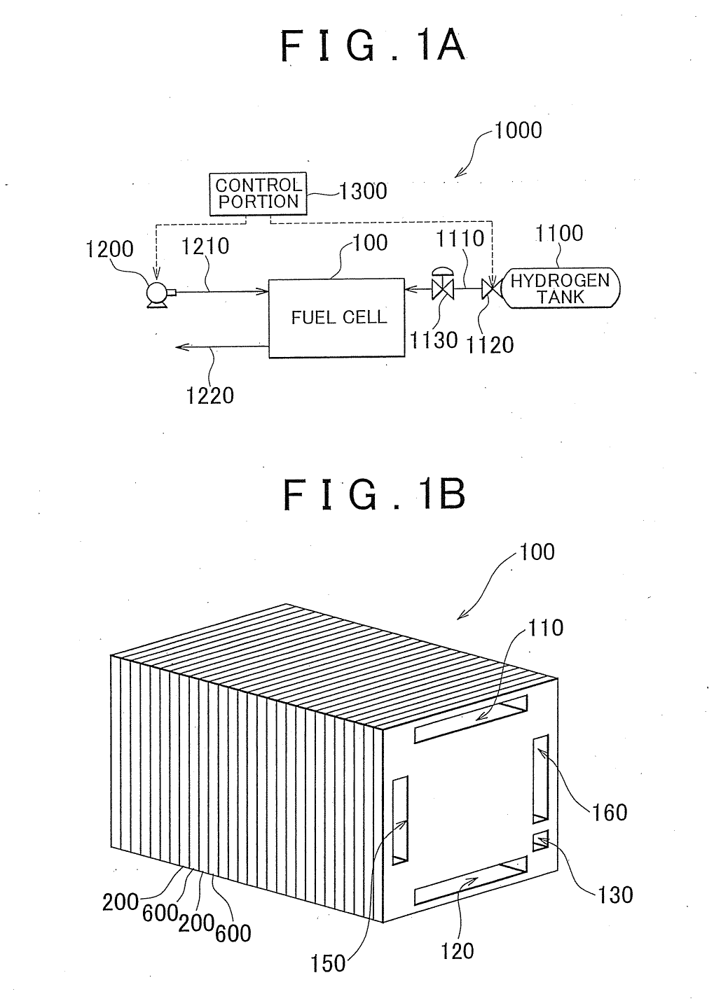

Firstly, a general construction of a fuel cell system 1000 having a fuel cell 100 in accordance with a first embodiment of the invention will be described. FIGS. 1A and 1B are illustrative diagrams of the fuel cell system 1000 and the fuel cell 100. Concretely, FIG. 1A is a block diagram of the fuel cell system 1000, and FIG. 1B is an external construction diagram of the fuel cell 100. This fuel cell system 1000, as shown in FIG. 1A, is equipped mainly with the fuel cell 100, a high-pressure hydrogen tank 1100, an air compressor 1200, a hydrogen shutoff valve 1120, a regulator 1130, and a control portion 1300.

The high-pressure hydrogen tank 1100 stores hydrogen as a fuel gas of the fuel cell 100. The high-pressure hydrogen tank 1100 is connected by a hydrogen supply piping 1110 to a fuel gas supply manifold (described below) of the fuel cell 100. The hydrogen supply piping 1110 is provided with the hydrogen shutoff valve 1120 on an upstream side, and with the regulator 1130 on a downstream side for adjusting the pressure of hydrogen.

The air compressor 1200 supplies high-pressure air as an oxidizing gas to the fuel cell 100. The air compressor 1200 is connected by an air supply piping 1210 to an oxidizing gas supply manifold (described below) of the fuel cell 100. The air supply piping 1210 may be provided with a humidifier. The amount of the oxidizing gas not given for use in the electrochemical reaction on the cathode of the fuel cell 100 is discharged to the outside of the fuel cell 100 via a discharge piping 1220 connected to an oxidizing gas discharge manifold (described below).

The control portion 1300 is constructed as a logic circuit with a microcomputer as a central unit. Specifically, the control portion 1300 is equipped with a CPU (not shown) that executes predetermined computations and the like by following pre-set control programs, a ROM (not shown) that pre-stores control programs, control data, etc. that are needed for the CPU to execute various computation processes, a RAM (not shown) that various data needed for the CPU to perform various computation processes are temporarily written into and read from, input/output ports (not shown) that inputs/outputs various signals, etc. The control portion 1300 is connected with the hydrogen shutoff valve 1120, the air compressor 1200, etc., via signal lines, and controls these devices and the like to accomplish the power generation by the fuel cell 100.

### A2. Construction of Fuel Cell 100

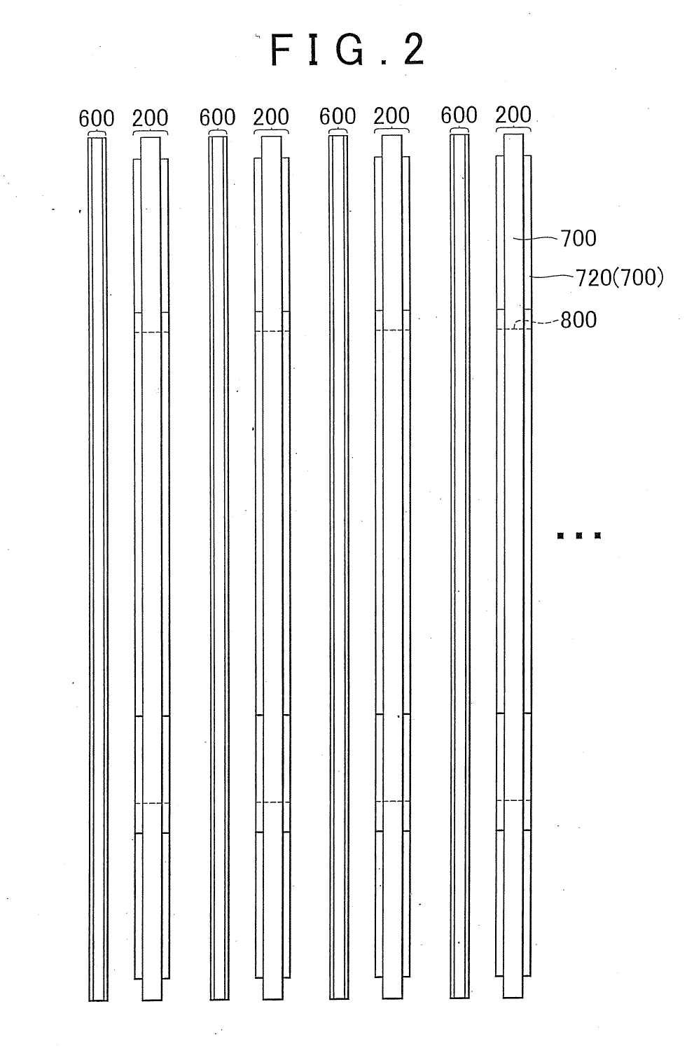

FIG. 2 is a side view of the fuel cell 100. As shown in FIG. 1B or FIG. 2, the fuel cell 100 has a structure (a so-called stack structure) in which seal-integrated power generation assemblies 200 and separators 600 are alternately stacked. The fuel cell 100 is manufactured by stacking predetermined numbers of seal-integrated power generation assemblies 200 and separators 600 and fastening them so that a predetermined fastening force is applied in the direction in which they are stacked (hereinafter, referred to as the stacking direction). Incidentally, although in FIG. 2, spaces are provided between the individual seal-integrated power generation assemblies 200 and the individual separators 600, these spaces do not exist in reality, and the seal-integrated power generation assemblies 200 and the separators 600 are in contact with each other. Hereinafter, the direction in which seal-integrated power generation assemblies 200 and separators 600 are stacked is also referred to as stacking direction. Details of a seal member 700 (rib 720) will be described later.

As shown in FIG. 1B, the fuel cell 100 is provided with an oxidizing gas supply manifold 110 in which the oxidizing gas is supplied, an oxidizing gas discharge manifold 120 for discharging the oxidizing gas, a fuel gas supply manifold 130 in which the fuel gas is supplied, a cooling medium supply manifold 150 for supplying a cooling medium, and a cooling medium discharge manifold 160 for discharging the cooling medium. Incidentally, the fuel cell 100 of this embodiment is not structured so as to discharge the fuel gas supplied to the anode side. Specifically, the fuel cell 100 has a closed structure in which the fuel gas supplied to the anode side is not discharged out (hereinafter, referred to also as anode dead-end structure). Therefore, the fuel cell 100 is not provided with a fuel gas discharge manifold for discharging the fuel gas. Besides, the oxidizing gas used in this construction is air, and the fuel gas is hydrogen. The cooling medium used herein may be water, a nonfreezing liquid such as ethylene glycol or the like, air, etc. The oxidizing gas used herein may be a mixture gas obtained by mixing a high concentration of oxygen into air. In addition, the fuel cell 100 of this embodiment is supplied with a relatively high-pressure fuel gas.

### A3. Seal-Integrated Power Generation Assembly 200

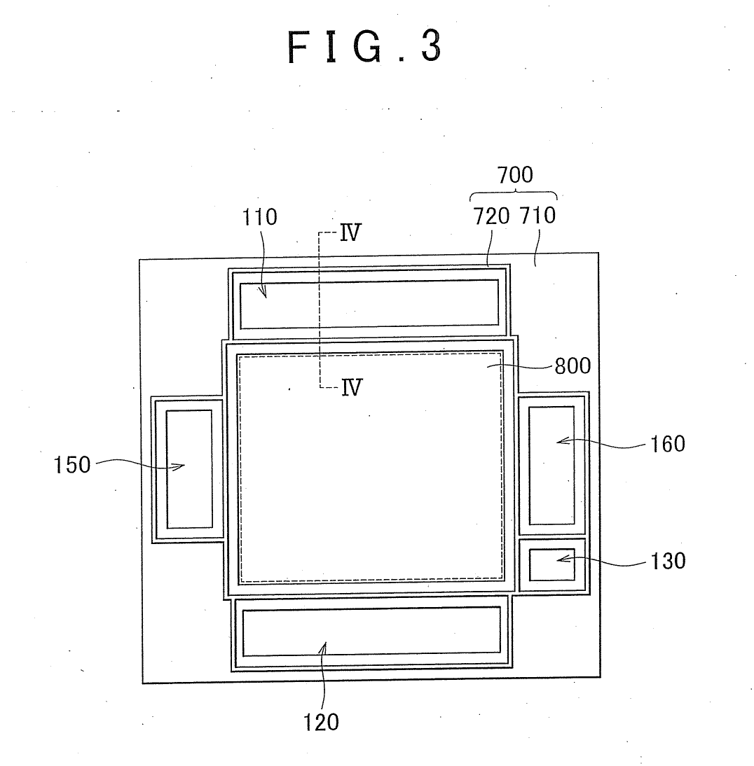

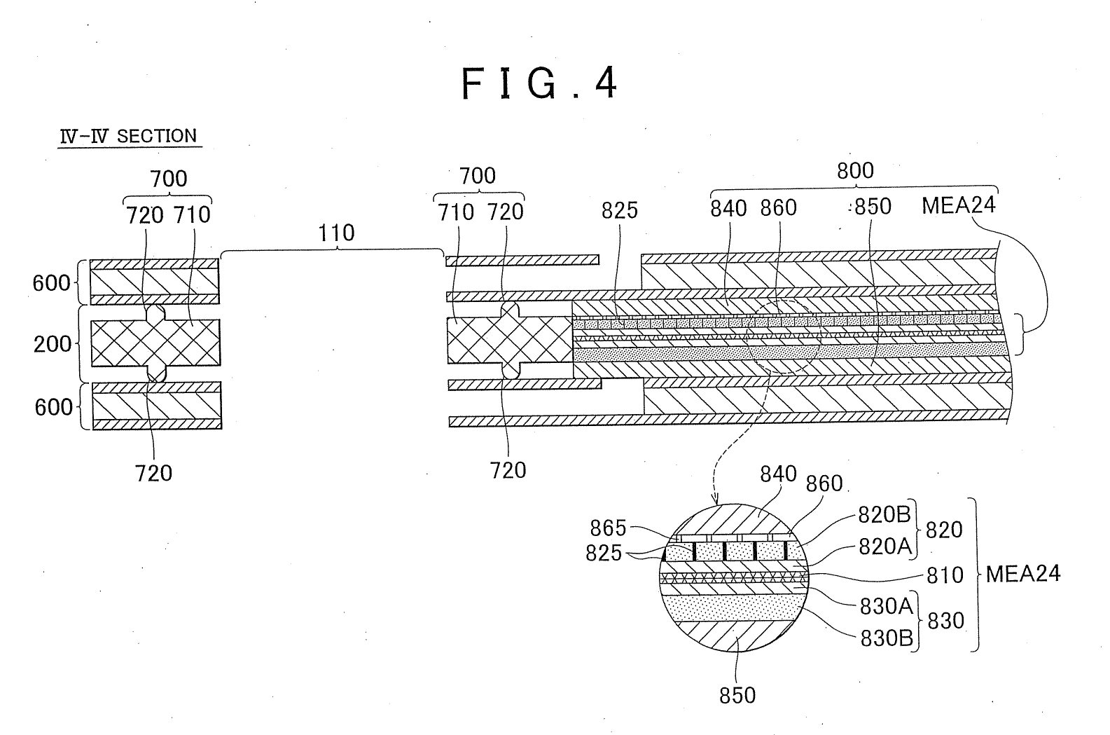

FIG. 3 is a front view of a seal-integrated power generation assembly 200 (a view taken from the right side of the seal-integrated power generation assembly 200 in FIG. 2). FIG. 4 is a sectional view showing a portion of a section of the seal-integrated power generation assembly 200 taken on line IV-IV in FIG. 3. FIG. 4 shows, in addition to the seal-integrated power generation assembly 200, two separators 600 that sandwich the seal-integrated power generation assembly 200 when a fuel cell is constructed.

The seal-integrated power generation assembly 200 is constructed of a laminate member 800 and a seal member 700 as shown in FIGS. 2, 3 and 4.

The laminate member 800, as shown in FIG. 4, is provided with a membrane-electrode assembly (hereinafter, also referred to as “MEA”) 24, an electroconductive sheet 860, an anode-side porous body 840, and a cathode-side porous body 850. The electroconductive sheet 860 is disposed between the MEA 24 and the anode-side porous body 840.

The MEA 24 is provided with an electrolyte membrane 810, an anode 820 and a cathode 830. The electrolyte membrane 810 is, for example, an ion exchange membrane that is formed of a fluorine-based resin material or a hydrocarbon-based resin material and that has good ion conductivity in a moist state. The anode 820 is made up of a catalyst layer 820A provided on one surface of the electrolyte membrane 810, and an anode-side diffusion layer 820B provided on a side surface of the catalyst layer 820A that is remote from the electrolyte membrane 810. The cathode 830 is made up of a catalyst layer 830A provided on the other side surface of the electrolyte membrane 810, and a cathode-side diffusion layer 830B provided on a side surface of the catalyst layer 830A that is remote from the electrolyte membrane 810. The catalyst layer 820A and the catalyst layer 830A are each formed from, for example, a catalyst support body supporting a catalyst (e.g., platinum or the like), and an electrolyte. The anode-side diffusion layer 820B and the cathode-side diffusion layer 830B are each formed of a porous material that has gas diffusivity and electroconductivity; for example, they are formed by, for example, a carbon cloth obtained by weaving a carbon-fiber yarn, a carbon paper, a carbon felt, a metal porous body, etc. The MEA 24 has a rectangular shape. Incidentally, partition wall portions 825 are formed within the anode-side diffusion layer 820B, and details thereof will be described later.

The anode-side porous body 840 and the cathode-side porous body 850 are each formed of a porous material that has gas diffusivity and electroconductivity, such as a metal porous substance or the like; for example, an expanded metal, a punched metal, a mesh, a felt, etc., may be used. Besides, when seal-integrated power generation assemblies 200 and separators 600 are stacked to construct a fuel cell 100, each anode-side porous body 840 and each cathode-side porous body 850 contact power generation portions DA (described later) of separators 600. Furthermore, the anode-side porous body 840, as described later, functions as a fuel gas supply channel for supplying the fuel gas to the anode 820. The cathode-side porous body 850, as described below, functions as an oxidizing gas supply channel for supplying the oxidizing gas to the cathode 830. Incidentally, the anode-side diffusion layer 820B and the cathode-side diffusion layer 830B used herein are lower in the internal gas flow resistance than the anode-side porous body 840 and the cathode-side porous body 850, respectively, that is, higher in gas permeability than the anode-side porous body 840 and the cathode-side porous body 850.

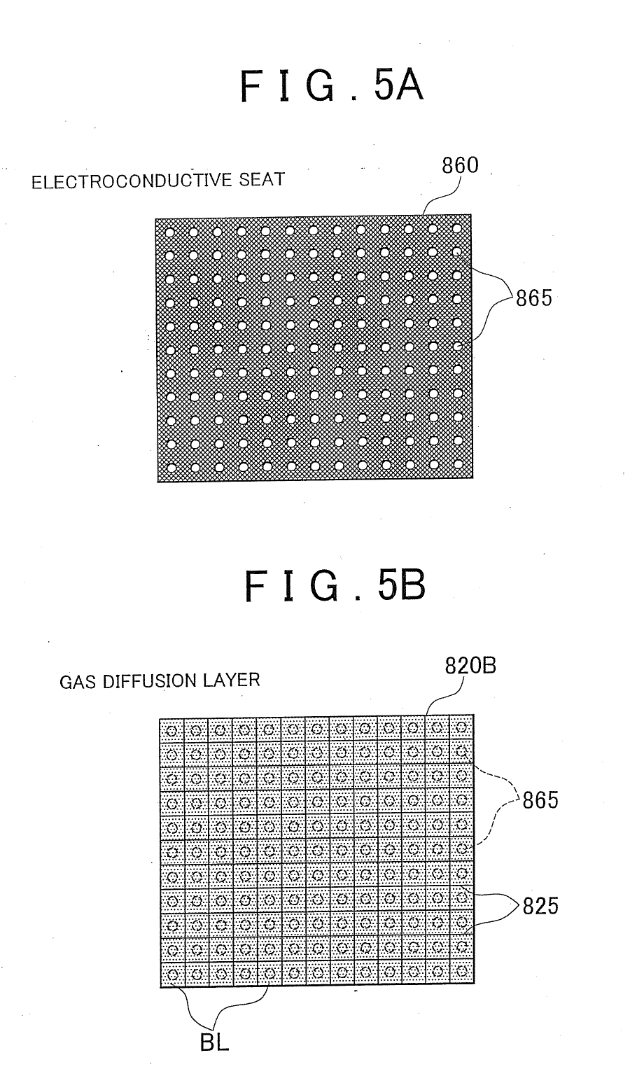

FIG. 5A is a front view of the electroconductive sheet 860, and FIG. 5B is a front view of the anode-side diffusion layer 820B. Concretely, FIG. 5A shows a view of the electroconductive sheet 860 taken from above in FIG. 4, and FIG. 5B shows a view of the anode-side diffusion layer 820B taken from above in FIG. 4. Incidentally, FIG. 5B shows a construction in which the anode-side diffusion layer 820B is stacked with the electroconductive sheet 860, and the positions in the anode-side diffusion layer 820B that correspond to the penetration holes 865 of the electroconductive sheet 860 are shown by dotted lines.

The electroconductive sheet 860 is formed in a sheet shape (thin film shape) as shown in FIG. 5A, and has many penetration holes 865 that are provided in a dispersed fashion in the surface. The penetration holes 865 are circular, and equal in the opening diameter (i.e. are the same in shape), and extend through the electroconductive sheet 860 in the thickness direction (the stacking direction), and are provided at the positions described later. The proportion of the area of the openings of the penetration holes 865 to the area of the sheet surface of the electroconductive sheet 860 is called numerical aperture. The numerical aperture of the electroconductive sheet 860 is set relatively small. The numerical aperture of the electroconductive sheet 860 is preferably less than 5%, and more preferably less than 3%, and particularly preferably less than 1%. Therefore, in the electroconductive sheet 860, the opening diameter of the penetration holes 865 is relatively small, and the pitch between the penetration holes 865 is relatively wide. Accordingly, the fuel gas passing through the penetration holes 865 results in a large pressure loss. This electroconductive sheet 860 is formed of gold, and is joined to one side surface of the anode-side porous body 840 by thermocompression bonding, brazing, welding, or the like. Incidentally, in FIGS. 5A and 5B, the opening diameter of the penetration holes 865 is shown relatively large in order to facilitate visual perception. In the following description, the directions along the plane of each member of the laminate member 800 in the fuel cell 100 are also referred to as planar directions.

Now, the partition wall portions 825 formed in the anode-side diffusion layer 820B will be described. The partition wall portions 825 extend in parallel with each other in the anode-side diffusion layer 820B in the thickness direction (stacking direction) from the electroconductive sheet 860-side surface to the catalyst layer 820A-side surface as shown in FIG. 4. Besides, the partition wall portions 825 are disposed as follows. That is, as shown in FIG. 5B, the partition wall portions 825 in the anode-side diffusion layer 820B divide the electroconductive sheet 860-side surface into a plurality of blocks in a lattice fashion (hereinafter, each block will be also referred to as block BL). In this construction, the penetration holes 865 of the electroconductive sheet 860 are arranged so as to correspond to (communicate with) the divided blocks in a one-to-one fashion. The partition wall portions 825 are formed by masking portions of the electroconductive sheet 860-side surface of the anode-side diffusion layer 820B other than the portions that form the partition wall portions 825 and then impregnating the anode-side diffusion layer 820B with a resin while the masking is maintained. The thus-fanned partition wall portions 825 restrain movements of the gas between the blocks BL in the anode-side diffusion layer 820B. Incidentally, the resin may be a gas-impermeable resin; for example, epoxy resin, PE resin, fluorocarbon resin, silicone resin, ABS resin, PP resin, or the like may be used.

The seal member 700 is disposed around an outer periphery of the laminate member 800 that is located in the planar directions. The seal member 700 is made by the injection molding of a molding material, and is gaplessly and air-tightly integrated with the outer peripheral end of the laminate member 800. The seal member 700 is foimed by a material that has gas impermeability, elasticity, and heat resistance in the operation temperature range of the fuel cell, for example, a rubber or an elastomer. Concretely, silicon-based rubber, butyl rubber, acrylic rubber, natural rubber, fluorocarbon rubber, ethylene-propylene-based rubber, styrene-based elastomer, fluorocarbon elastomer, etc. can be used.

The seal member 700, as shown in FIGS. 2 to 4, has a support portion 710, and ribs 720 that are disposed on both sides of the support portion 710 and that form seal lines. As shown in FIG. 3, the support portion 710 has penetration holes (manifold holes) that correspond to the manifolds 110 to 160 (see FIG. 1B). When the seal-integrated power generation assembly 200 and separators 600 are stacked, the ribs 720 closely attach to the adjacent separators 600 so as to seal the outer periphery of the seal-integrated power generation assembly 200 and therefore prevent leakage of the reactant gases and the cooling water. The ribs 720 form a seal line that surrounds the entire periphery of the laminate member 800, and seal lines that surround the entire peripheries of the individual manifold holes in FIG. 3.

### A4. Construction of Separator 600

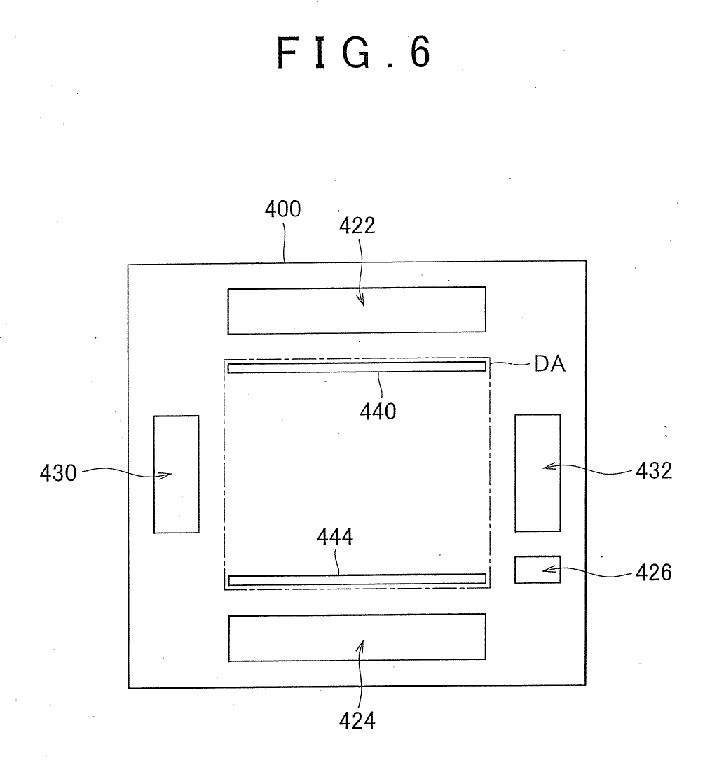

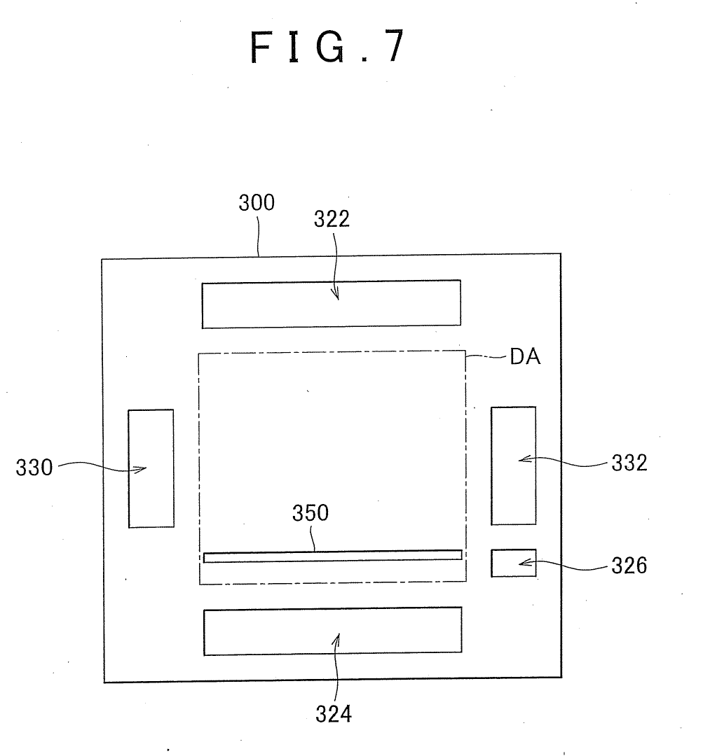

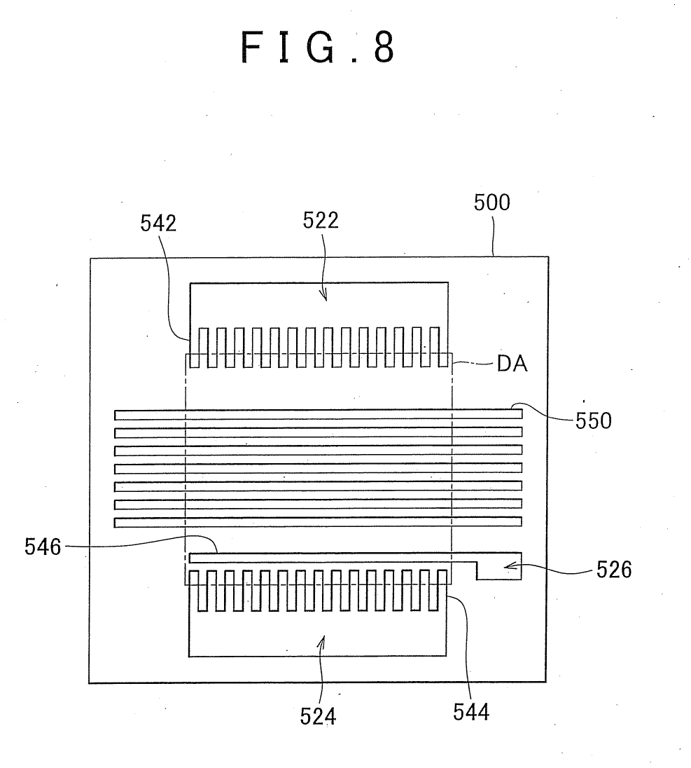

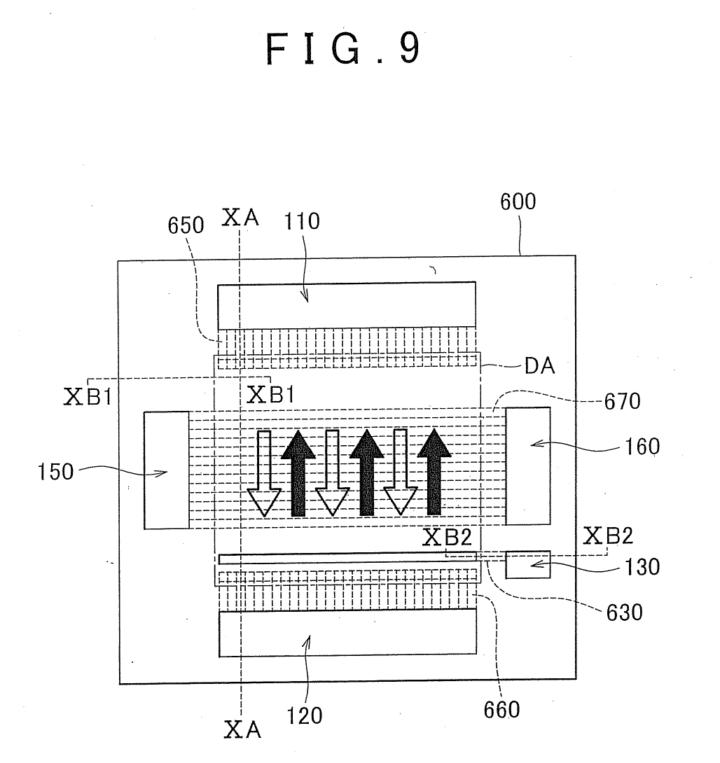

FIG. 6 is an illustrative diagram showing a shape of the cathode plate 400 of the separator 600. FIG. 7 is an illustrative diagram showing a shape of the anode plate 300 of the separator 600. FIG. 8 is an illustrative diagram showing a shape of the intermediate plate 500 of the separator 600. FIG. 9 is a front view of the separator 600. With reference to FIGS. 6 to 9, the construction of the separator 600 will be described. The separator 600 is constructed of the cathode plate 400, the anode plate 300, and the intermediate plate 500 shown in FIGS. 6 to 8. Incidentally, FIGS. 6, 7 and 8 show the views of the plates 400, 300 and 500, respectively, that are taken from the right side in FIG. 2. In addition, solid and hollow arrows in FIG. 9 will be explained later.

In FIGS. 6 to 9, a region DA shown by a dashed line in a central portion of each of the plates 300, 400, 500 and the separator 600 is a region that corresponds to the MEA 24 contained in the laminate member 800 of each seal-integrated power generation assembly 200 when separators 600 and seal-integrated power generation assemblies 200 are stacked together to form a fuel cell 100. Since the MEA 24 is a region in which power generation actually occurs, this region will be referred to as the power generation portion DA below. Since the MEA 24 is rectangular, the power generation portion DA is naturally rectangular.

The cathode plate 400 (FIG. 6) is formed, for example, of a stainless steel. The cathode plate 400 has five manifold-forming portions 422 to 432, an oxidizing gas supply slit 440, and an oxidizing gas discharge slit 444. The manifold-forming portions 422 to 432 are penetration opening portions for forming the foregoing various manifolds when the fuel cell 100 is constructed. The manifold-forming portions 422 to 432 are provided outside the power generation region DA. Concretely, the manifold-forming portions 422, 424 corresponding to the oxidizing gas supply manifold and the oxidizing gas discharge manifold are disposed outside the power generation portion DA and along a pair of sides of the power generation portion DA that are opposite to each other, respectively. The manifold-forming portions 430, 432 corresponding to the cooling medium supply manifold and the cooling medium discharge manifold are disposed outside the power generation portion DA and along the other pair of sides of the power generation portion DA that are opposite to each other, respectively. The oxidizing gas supply slit 440 is an elongated hole having a generally rectangular shape, and is disposed inside the power generation portion DA and along the upper side of the power generation portion DA (the side adjacent to the oxidizing gas supply manifold). The oxidizing gas discharge slit 444 is similarly an elongated hole having a generally rectangular shape, and is disposed inside the power generation portion DA and along the lower side of the power generation portion DA (the side thereof adjacent to the oxidizing gas discharge manifold).

The anode plate 300 (FIG. 7), similarly to the cathode plate 400, is formed, for example, of a stainless steel. The anode plate 300, similarly to the cathode plate 400, has five manifold-forming portions 322 to 332, and a fuel gas supply slit 350. The manifold-forming portions 322 to 332 are penetration opening portions for forming the foregoing various manifolds when the fuel cell 100 is constructed. As in the cathode plate 400, the manifold-forming portions 322 to 332 are provided outside the power generation region DA. The fuel gas supply slit 350 is disposed inside the power generation region DA and along a lower side of the power generation region DA (the side thereof adjacent to the oxidizing gas discharge manifold) so as not to overlap with the oxidizing gas discharge slit 444 of the cathode plate 400 when the separator 600 is constructed.

The intermediate plate 500, (FIG. 8), similar to the plates 300, 400, is formed, for example, of a stainless steel. The intermediate plate 500 has, as penetration opening portions that penetrate therethrough in the thickness direction (stacking direction), three manifold-forming portions 522 to 526 for supplying/discharging a reactant gas (the oxidizing gas or the fuel gas), a plurality of oxidizing gas introduction channel-forming portions 542, a plurality of oxidizing gas discharge channel-forming portions 544, and a fuel gas introduction channel-forming portion 546. The intermediate plate 500 further has a plurality of cooling medium channel-forming portions 550. The manifold-forming portions 522 to 526 are penetration opening portions for forming the foregoing various manifolds when the fuel cell 100 is constructed. As in the cathode plate 400 and the anode plate 300, the manifold-forming portions 522 to 526 are provided outside the power generation region DA.

Each of the cooling medium channel-forming portions 550 has an elongated hole shape that extends across the power generation region DA in the left-right direction in FIG. 8, and two ends thereof reach the outside of the power generation region DA.

In the intermediate plate 500 (FIG. 8), an end of each of the oxidizing gas introduction channel-forming portions 542 is linked in communication with the manifold-forming portion 522, that is, the oxidizing gas introduction channel-forming portions 542 and the manifold-forming portion 522 form a comb-shape penetration hole as a whole. The opposite end of each of the oxidizing gas introduction channel-forming portions 542 extends to such a position as to overlap with the oxidizing gas supply slit 440 of the cathode plate 400 when the three plates are joined to construct the separator 600. As a result, when the separator 600 is constructed, the oxidizing gas introduction channel-forming portions 542 individually link in communication to the oxidizing gas supply slit 440.

In the intermediate plate 500 (FIG. 8), an end of each of the oxidizing gas discharge channel-forming portions 544 is linked in communication to the manifold-forming portion 524, that is, the oxidizing gas discharge channel-forming portions 544 and the manifold-forming portion 524 form a comb-shape penetration hole as a whole. The opposite end of each of the oxidizing gas discharge channel-forming portions 544 extends to such a position as to overlap with the oxidizing gas discharge slit 444 of the cathode plate 400 when the three plates are joined to construct the separator 600. As a result, when the separator 600 is constructed, the oxidizing gas discharge channel-forming portions 544 individually link in communication to the oxidizing gas discharge slit 444.

In the intermediate plate 500 (FIG. 8), an end of the fuel gas introduction channel-forming portion 546 is linked in communication to the manifold-forming portion 526. The fuel gas introduction channel-forming portion 546 extends along the lower side of the power generation region DA (the side thereof adjacent to the manifold-forming portion 524), at such a position as not to overlap with the oxidizing gas discharge channel-forming portions 544. The opposite end of the fuel gas introduction channel-fowling portion 546 reaches the vicinity of the leftward side of the power generation region DA (the side thereof remote from the manifold-forming portion 526). Of the fuel gas introduction channel-forming portion 546, a portion located inside the power generation region DA overlaps with the fuel gas supply slit 350 of the anode plate 300 when the three plates are joined to construct the separator 600. As a result, when the separator 600 is constructed, the fuel gas introduction channel-forming portion 546 links in communication to the fuel gas supply slit 350.

The separator 600 (FIG. 9) is manufactured by joining the three plates so that the intermediate plate 500 is sandwiched by the anode plate 300 and the cathode plate 400, and punching the regions 150, 160 that correspond to the cooling medium supply manifold 150 and the cooling medium discharge manifold 160, respectively, so that the regions 150, 160 are exposed. The method used to join the three plates may be, for example, theremocompression bonding, brazing, welding, etc. As a result, a separator 600 having five manifolds 110 to 160 that are penetration opening portions in FIG. 9, a plurality of oxidizing gas introduction channels 650, a plurality of oxidizing gas discharge channels 660, a fuel gas introduction channel 630, and a plurality of cooling medium channels 670 is obtained.

As shown in FIG. 9, the oxidizing gas introduction channels 650 are formed by the oxidizing gas supply slit 440 of the cathode plate 400 and the oxidizing gas introduction channel-forming portions 542 of the intermediate plate 500. Each of the oxidizing gas introduction channels 650 is an internal channel that passes within the separator 600, and an end thereof is linked in communication to the oxidizing gas supply manifold 110, and another end thereof reaches the surface on the cathode plate 400 side (the cathode-side surface), and has an opening in the cathode-side surface. As shown in FIG. 9, the oxidizing gas discharge channels 660 are formed by the oxidizing gas discharge slit 444 of the cathode plate 400 and the oxidizing gas discharge channel-forming portions 544 of the intermediate plate 500. Each of the oxidizing gas discharge channels 660 is an internal channel that passes within the separator 600, and an end thereof is linked in communication to the oxidizing gas discharge manifold 120, and another end thereof reaches the cathode-side surface on the cathode plate 400 side, and has an opening in the cathode-side surface.

As shown in FIG. 9, the fuel gas introduction channel 630 is formed by the fuel gas supply slit 350 of the anode plate 300 and the fuel gas introduction channel-forming portion 546 of the intermediate plate 500. The fuel gas introduction channel 630 is an internal channel that is linked in communication, at an end thereof, to the fuel gas supply manifold 130, and that, at the other end thereof, has an opening in the anode-side surface. Besides, the cooling medium channels 670 are formed by the cooling medium channel-forming portions 550 (FIG. 8) formed in the intermediate plate 500, and are each linked in communication, at an end thereof, to the cooling medium supply manifold 150, and at the other end thereof, to the cooling medium discharge manifold 160.

### A5. Operations of Fuel Cell 100

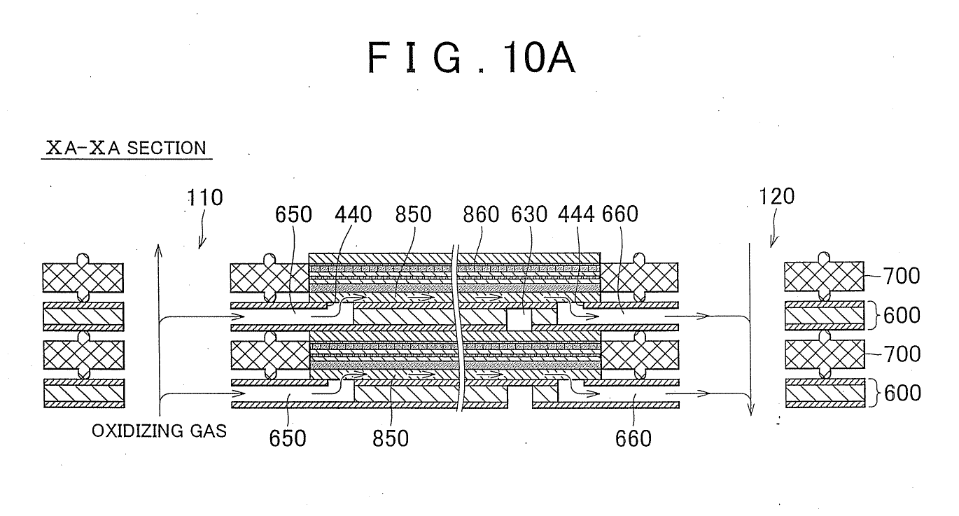

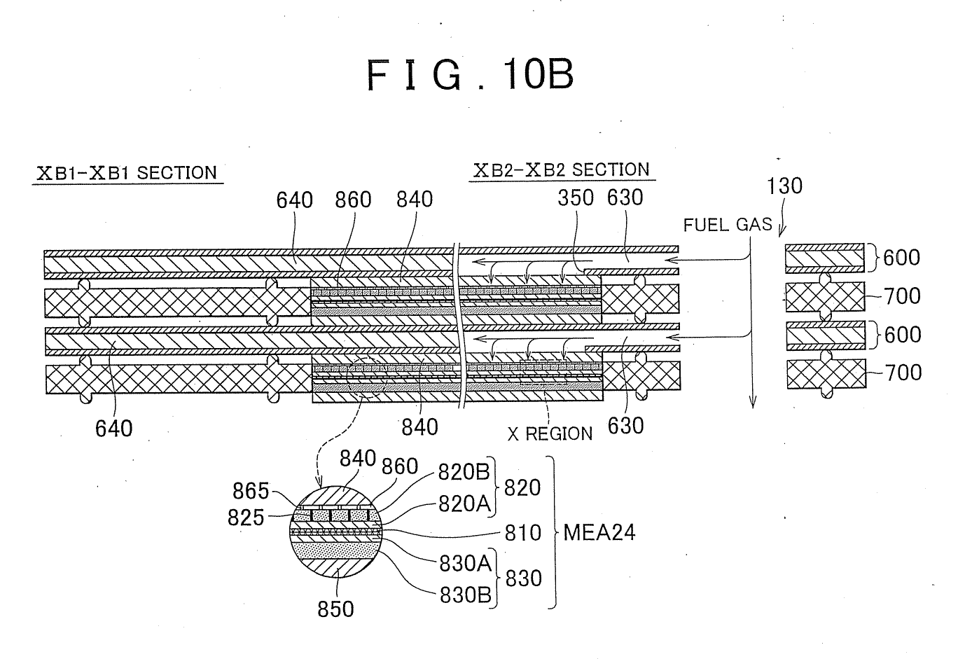

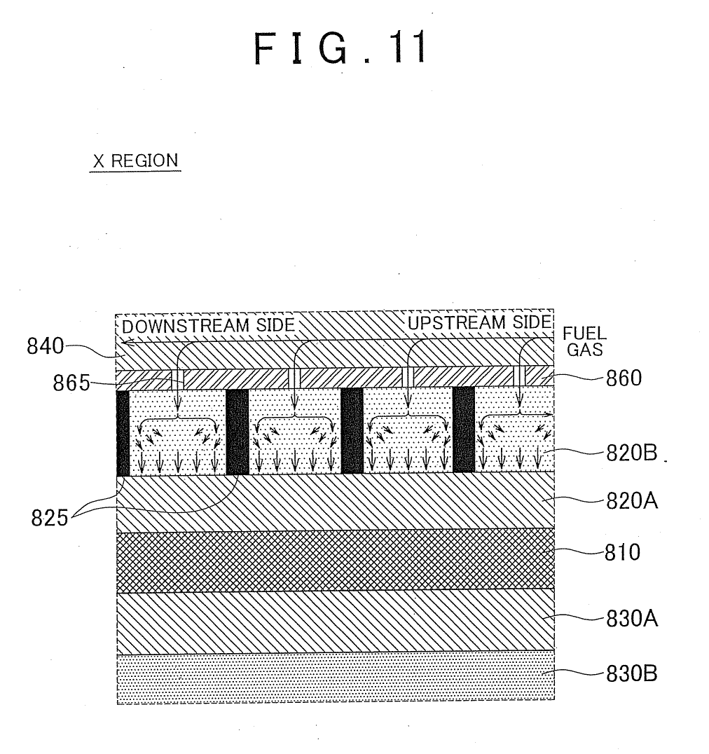

FIGS. 10A and 10B are illustrative diagrams showing the flows of the reaction gases inside the fuel cell 100 of the embodiment. FIG. 11 is an enlarged view of an X region shown in FIG. 10B. To facilitate visual perception, FIGS. 10A and 10B show only a state in which two seal-integrated power generation assemblies 200 and two separators 600 are stacked. FIG. 10A shows a sectional view corresponding to line XA-XA in FIG. 9. In FIG. 10B, a right-side half of the illustration shows a sectional view corresponding to line XB2-XB2 in FIG. 9, and a left-side half thereof shows a sectional view corresponding to line XB1-XB1 in FIG. 9. Besides, in FIGS. 10A, 10B and 11, the flows of the reactant gas are shown by arrows. In FIG. 11, since the fuel gas flows from the right to the left, the right side is also referred to as the upstream side and the left side is also referred to as the downstream side.

The fuel cell 100 generates electric power with the oxidizing gas supplied to the oxidizing gas supply manifold 110 and the fuel gas supplied to the fuel gas supply manifold 130. During the power generation of the fuel cell 100, the cooling medium is supplied to the cooling medium supply manifold 150, and is then supplied to the cooling medium channels 670 (not shown), in order to restrain the temperature rise of the fuel cell 100 caused by the heat generation involved in the power generation. The cooling medium supplied into the cooling medium channels 670 flows from one end of each cooling medium channel 670 to the other end thereof undergoing heat exchange, and then is discharged into the cooling medium discharge manifold 160 (not shown).

The oxidizing gas supplied to the oxidizing gas supply manifold 110 passes, as shown by arrows in FIG. 10A, from the oxidizing gas supply manifold 110 through the oxidizing gas introduction channels 650, and then flows into the cathode porous bodies 850 via the oxidizing gas supply slits 440 (FIG. 6). The oxidizing gas that has flown into the cathode porous bodies 850 flows, as shown by hollow arrows in FIG. 9, within the cathode porous bodies 850 that function as oxidizing gas supply channels. Then, the oxidizing gas flows into the oxidizing gas discharge channels 660 from the oxidizing gas discharge slits 444 (FIG. 6), and is discharged into the oxidizing gas discharge manifold 120. A portion of the oxidizing gas flowing in each cathode-side porous body 850 diffuses in the entire cathode-side diffusion layer 830B that is in contact with the cathode-side porous body 850, and is given for use in the cathode reaction in the catalyst layer 830A (e.g., 2H⁺+2e⁻+(½)O₂→H₂O).

The fuel gas supplied to the fuel gas supply manifold 130 passes, as shown by arrows in FIG. 10B, from the fuel gas supply manifold 130 through the fuel gas introduction channels 630, and then flows into the anode-side porous bodies 840 via the fuel gas supply slits 350 (FIG. 7). The fuel gas that has flown into the anode-side porous bodies 840 flows, as shown by solid arrows in FIG. 9, within the anode-side porous bodies 840 that function as fuel gas supply channels. At this time, the fuel gas, as shown in FIG. 11, flows from the penetration holes 865 of the electroconductive sheets 860 in contact with the anode-side porous bodies 840 into the blocks BL of the anode-side diffusion layers 820B in a direction perpendicular to the planar directions (i.e., the stacking direction), and diffuses in each block BL, and is given for use in the anode reaction in the catalyst layers 820A (e.g., H₂→2H⁺+2e⁻).

The fuel cell 100 in this embodiment has an anode dead-end structure without any fuel gas discharge channel or any fuel gas discharge channel, so that the fuel gas supplied to each anode-side porous body 840 is substantially entirely absorbed into and consumed in the anode 820. Herein, the “consumption” is a concept that includes the use of the fuel gas in the electrochemical reaction on the anode 820 and also includes the leakage of the fuel gas to the cathode 830 side.

In each laminate member 800, the electroconductive sheet 860 having penetration holes 865 is provided between the anode 820 (the anode-side diffusion layer 820B) and the anode-side porous body 840. In this case, the fuel gas undergoes a large pressure loss when passing through the penetration holes 865. Then, a large pressure difference occurs between the anode 820 (the anode-side diffusion layer 820B) and the anode-side porous body 840; specifically, the pressure becomes considerably higher in the anode-side porous body 840 than in the anode 820 (the anode-side diffusion layer 820B). In association with the large pressure difference, the flow speed of the fuel gas becomes fast, so that the flow speed of the fuel gas becomes faster than the diffusion speed of the leak gas that is made up of nitrogen from air leaking from the cathode side to the anode side, or the like. As a result, the leak gas is restrained from moving from the anode-side diffusion layer 820B into the anode-side porous body 840 (the fuel gas supply channel), and the leak gas is restrained from residing in the anode-side porous body 840 (the fuel gas supply channel).

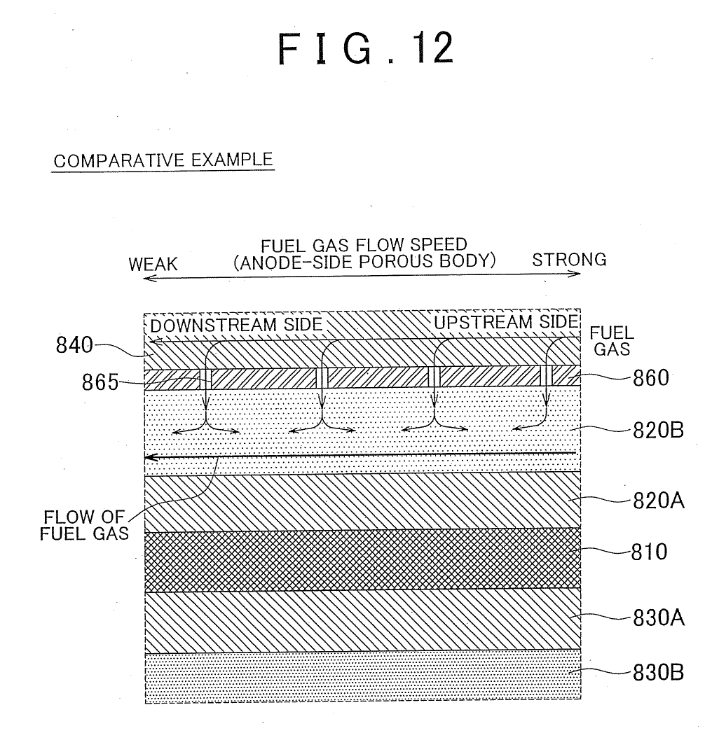

The efficacy of the fuel cell 100 of this embodiment will be considered in comparison with a fuel cell as a comparative example shown in FIG. 12. FIG. 12 is a diagram of a fuel cell as a comparative example, showing how the fuel gas diffuses in an anode-side diffusion layer 820B that does not have a partition wall portion 825. The reference numerals used for portions of the fuel cell in this comparative example are substantially the same as those used in the foregoing embodiment. In FIG. 12, the right side is also referred to as the upstream side, and the left side is also referred to as the downstream side. In the fuel cell of the comparative example, the flow speed of the fuel gas in the anode-side porous body 840 gradually declines from the upstream side to the downstream side due to the internal flow resistance. Accordingly, as for the penetration holes 865, the flow speed of the fuel gas passing through a penetration hole 865 gradually becomes slower the further downstream the penetration hole 865 is located. Then, in the anode-side diffusion layer 820B, the diffusion flow speed of the fuel gas in the planar directions also radually becomes slower toward the downstream side. As a result, there is a possibility that a flow of the fuel gas from the upstream side to the downstream side may occur as shown in FIG. 12.

The leak gas leaks into the anode-side diffusion layer 820B as mentioned above. If there occurs a flow of the fuel gas from the upstream side toward the downstream side in the anode-side diffusion layer 820B as stated above, the leak gas cannot diffuse against the flow of the fuel gas, and therefore may accumulate in the downstream side of the anode-side diffusion layer 820B. Hence, there is a possibility that the supply of the fuel gas to portions of the catalyst layer 820A that correspond to the portions of the anode-side diffusion layer 820B in which the leak gas is accumulated may be inhibited.

On the other hand, the fuel cell 100 of the embodiment is equipped with the partition wall portions 825 that divide the anode-side diffusion layer 820B into a plurality of blocks BL. With this construction, the fuel gas can be restrained from flowing in the planar directions (from the upstream side to the downstream side) in the anode-side diffusion layer 820B, and therefore the leak gas can be restrained from locally residing, for example, in the lower side or the like, in the anode-side diffusion layer 820B. As a result, it becomes possible to supply the fuel gas to the catalyst layer 820A (the cathode 830) in a dispersed fashion. Therefore, the power generation efficiency of the fuel cell 100 can be improved.

The anode-side diffusion layer 820B is divided into a plurality of blocks BL by the partition wall portions 825 as described above. Therefore, there is possibility of the concentration of the leak gas heightening in a certain block BL. However, in the fuel cell 100 of the embodiment, the fuel gas is supplied at relatively high pressure. Therefore, in a block BL with a heightened leak gas concentration, the fuel gas is inhibited from being supplied into a portion of the catalyst layer 820A that corresponds to the block BL, so that the fuel gas concentration in that block BL gradually heightens. Accordingly, the leak gas in the block BL is forced back to the cathode 830 side. Hence, in each block BL, the abnormal heightening of the leak gas concentration can be restrained, so that the power generation efficiency of the fuel cell 100 can be improved.

In the fuel cell 100 of this embodiment, the partition wall portions 825 are arranged so that each block BL corresponds to one of the penetration holes 865 of the electroconductive sheet 860. This will restrain the leak gas from locally residing in blocks BL in the anode-side diffusion layer 820B.

Furthermore, in the fuel cell 100 of this embodiment, the anode-side diffusion layer 820B employed is lower in the internal flow resistance to gas than the anode-side porous body 840. With this construction, the fuel gas supplied into the anode-side diffusion layer 820B via the penetration holes 865 of the electroconductive sheet 860 can be helped to diffuse within the individual blocks BL of the anode-side diffusion layer 820B.

In the fuel cell 100 of the embodiment, the supply pressure of the fuel gas supplied into the fuel gas supply channel (hereinafter, also referred to as the fuel gas supply pressure) and the supply pressure of the oxidizing gas supplied into the oxidizing gas supply channel (also referred to as the oxidizing gas supply pressure) may be set so that the minimum value of the pressure of the fuel gas flowing in the fuel gas supply channel becomes higher than the maximum value of the partial pressure of the leak gas that leaks into the anode 820 from the cathode 830 via the electrolyte membrane 810. This setting may be provided by adjusting only one of the fuel gas supply pressure and the oxidizing gas supply pressure, or may also be provided by adjusting both the fuel gas supply pressure and the oxidizing gas supply pressure. Incidentally, the set values of the fuel gas supply pressure and/or the oxidizing gas supply pressure are determined on the basis of experimental data that is empirically obtained.

In the foregoing embodiment, the anode 820 may be regarded as an anode or an anode-forming layer, and the cathode 830 may be regarded as a cathode. The anode-side diffusion layer 820B may be regarded as a gas diffusion layer, and the partition wall portions 825 may be regarded as a partition wall portion. The electroconductive sheet 860 may be regarded as a gas introduction portion or an electroconductive sheet portion, and the penetration holes 865 may be regarded as a gas passage portion or a penetration hole, and the anode-side porous body 840 may be regarded as a channel-forming member.

### B. Second Embodiment

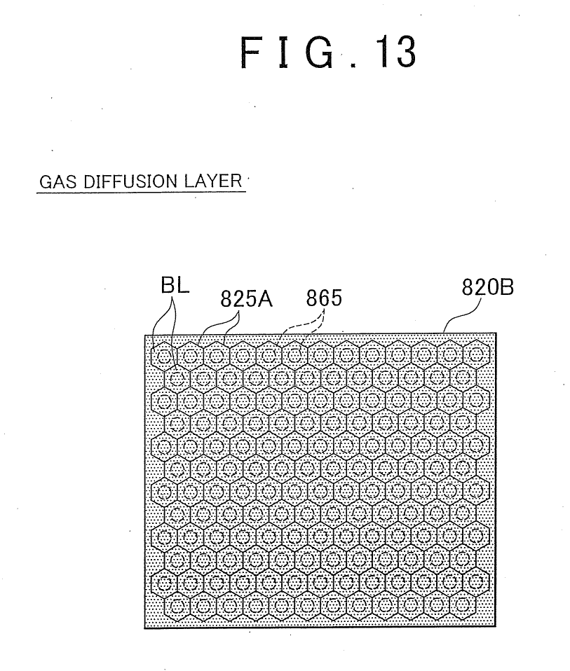

FIG. 13 is a front view of an anode-side diffusion layer 820B in a fuel cell 100A in accordance with a second embodiment of the invention. The drawing of FIG. 13 corresponds to the drawing of FIG. 5B regarding the fuel cell 100 of the first embodiment. Besides, in FIG. 13, the positions in the anode-side diffusion layer 820B that correspond to penetration holes 865 of an electroconductive sheet 860 in the case where the anode-side diffusion layer 820B is stacked with the electroconductive sheet 860 are shown by dotted lines.

The fuel cell 100A of this embodiment is basically the same in construction as the fuel cell 100 of the first embodiment, but has partition wall portions 825A that are different from the partition wall portions 825 of the first embodiment. In the fuel cell 100A, portions that are the same in construction as those of the first embodiment are assigned with the same reference characters, and descriptions thereof are omitted.

The partition wall portions 825A provided in the fuel cell 100A of this embodiment are partition walls that extend in parallel with each other in the anode-side diffusion layer 820B in the thickness direction (stacking direction) from an electroconductive sheet 860-side surface to a catalyst layer 820A-side surface, similarly to the partition wall portions 825 of the first embodiment. Furthermore, as shown in FIG. 13, the partition wall portions 825A in the anode-side diffusion layer 820B divide an electroconductive sheet 860-side surface into a plurality of blocks BL in a honeycomb fashion. Specifically, the plurality of blocks are formed in a honeycomb fashion in a view taken in the thickness direction (stacking direction). Besides, as shown in FIG. 13, each penetration hole 865 of the electroconductive sheet 860 is disposed so as to face a substantially central portion of the electroconductive sheet 860-side surface of the anode-side diffusion layer 820B in a corresponding one of the blocks BL. Each block BL has the shape of a generally regular hexagon, and there is not a very large difference between the distance of a vertex portion of the partition wall portions 825A from the portion that corresponds to the penetration hole 865 and the distance of a planar portion of the partition wall portions 825A from the portion that corresponds to the penetration hole 865. Therefore, the fuel gas, supplied into the blocks BL via the penetration holes 865, easily spreads to the corners of each block BL, that is, easily diffuses in each block BL. Besides, since the blocks BL are formed in a honeycomb fashion, the distribution of surface pressure can be uniformized in the anode-side diffusion layer 820B.

### C. Third Embodiment

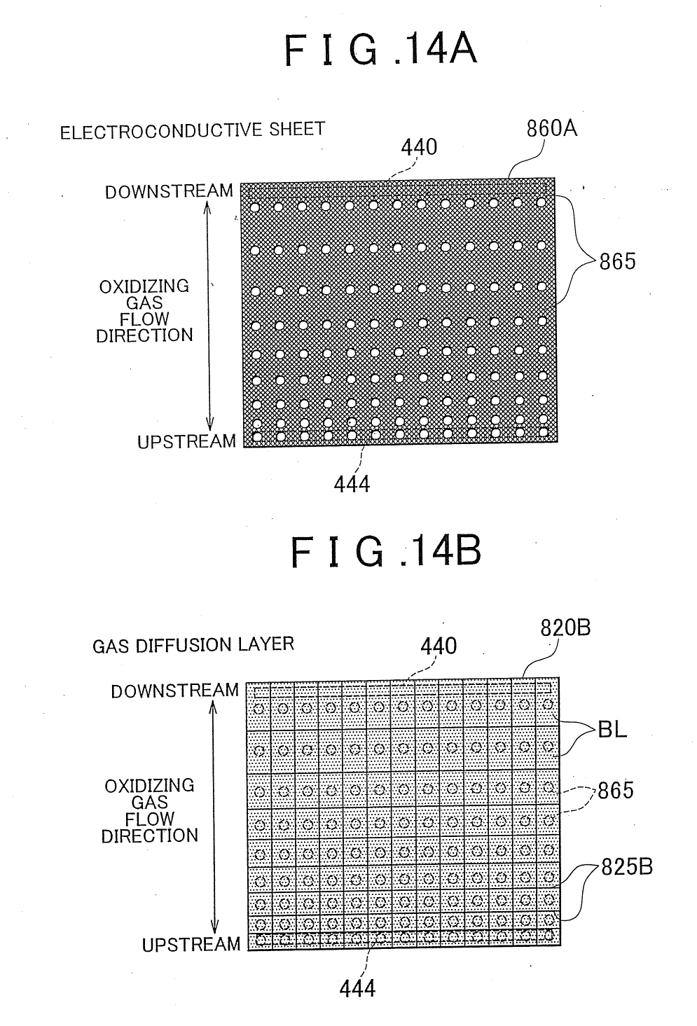

FIG. 14A is a front view of an electroconductive sheet 860A in a fuel cell 100B in accordance with a third embodiment of the invention, and FIG. 14B is a front view of an anode-side diffusion layer 820B. The drawings of FIGS. 14A and 14B correspond to the drawings FIGS. 5A and 5B regarding the fuel cell 100 of the first embodiment. Besides, in FIG. 14B, the positions in the anode-side diffusion layer 820B that correspond to penetration holes 865 of an electroconductive sheet 860A in the case where the anode-side diffusion layer 820B is stacked with the electroconductive sheet 860 are shown by dotted lines.

The fuel cell 100B of this embodiment is basically the same in construction as the fuel cell 100 of the first embodiment, but has an arrangement of the penetration holes 865 in the electroconductive sheet 860A that is different from the arrangement thereof in the electroconductive sheet 860 of the first embodiment, and has partition wall portions 825B that are different from the partition wall portions 825 of the first embodiment. In the fuel cell 100B, portions that are the same in construction as those of the first embodiment are assigned with the same reference characters, and descriptions thereof are omitted.

In the electroconductive sheet 860A provided in the fuel cell 100B of this embodiment, as shown in FIG. 14A, the penetration holes 865 are arranged so that the pitch between the penetration holes 865 becomes narrower from the downstream side toward the upstream side in the flowing direction of the oxidizing gas, that is, the intervals between the penetration holes 865 become shorter from the downstream side toward the upstream side in the flowing direction of the oxidizing gas. In other words, the penetration holes 865 are arranged so that the pitch between the penetration holes 865 becomes wider from the upstream side to the downstream side in the flowing direction of the oxidizing gas, that is, the intervals between the penetration holes 865 become longer from the upstream side toward the downstream side in the flowing direction of the oxidizing gas.

The partition wall portions 825B, similar to the partition wall portions 825 of the first embodiment, extend in parallel with each other in the anode-side diffusion layer 820B in the thickness direction (stacking direction) from the electroconductive sheet 860A-side surface to the catalyst layer 820A-side surface of the anode-side diffusion layer 820B. Furthermore, as shown in FIG. 14B, the partition wall portions 825B in the anode-side diffusion layer 820B divides the electroconductive sheet 860A-side surface into a plurality of blocks BL so that the area of a block BL becomes smaller from the downstream side toward the upstream side in the flowing direction of the oxidizing gas. In other words, the partition wall portions 825B divides the electroconductive sheet 860A-side surface into a plurality of blocks BL so that the area of a block BL becomes larger from the upstream side toward the downstream side in the flowing direction of the oxidizing gas. That is, in the anode-side diffusion layer 820B, the blocks BL are formed so that the volume of a block BL becomes smaller from the downstream side toward the upstream side in the flowing direction of the oxidizing gas. In this case, as shown in FIG. 14B, the penetration holes 865 of the electroconductive sheet 860A are arranged so that each penetration hole 865 faces a substantially central portion of the electroconductive sheet 860-side surface in a corresponding one of the blocks BL.

Incidentally, in the anode 820, the amount of generated current becomes larger from the downstream side toward the upstream side in the flowing direction of the oxidizing gas, that is, the amount of the fuel gas demanded becomes larger from the downstream side toward the upstream side in the flowing direction of the oxidizing gas. In the fuel cell 100B of this embodiment, the blocks BL are formed so that the volume of a block BL becomes smaller from the downstream side toward the upstream side in the flowing direction of the oxidizing gas. With this construction, blocks BL located in the upstream side in the flowing direction of the oxidizing gas are supplied with more fuel gas than downstream-side blocks BL. Therefore, in the MEA 24, large amounts of the fuel gas can be supplied to portions where the amount of generated current is large, and therefore in the fuel cell 100B, the power generation efficiency can be improved.

### D. Fourth Embodiment

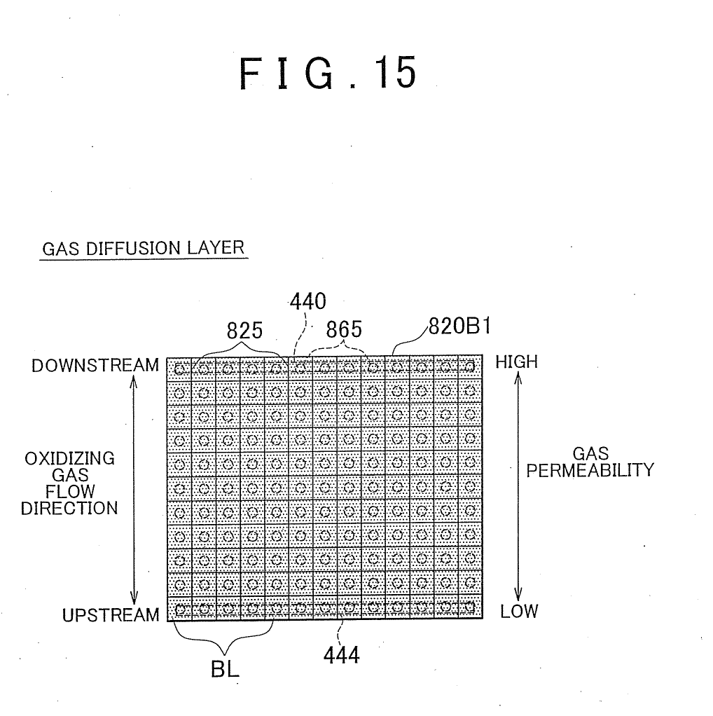

FIG. 15 is a front view of an anode-side diffusion layer 820B1 in a fuel cell 100C in accordance with a fourth embodiment of the invention. The drawing of FIG. 15 corresponds to the drawing of FIG. 5B regarding the fuel cell 100 of the first embodiment. Besides, in FIG. 15, the positions in the anode-side diffusion layer 820B1 that face penetration holes 865 of an electroconductive sheet 860 in the case where the anode-side diffusion layer 820B1 is stacked with the electroconductive sheet 860 are shown by dotted lines.

The fuel cell 100C of this embodiment is basically the same in construction as the fuel cell 100 of the first embodiment, but has anode-side diffusion layers 820B1 that are different from the anode-side diffusion layers 820B of the first embodiment. In the fuel cell 100C, portions that are the same in construction as those of the first embodiment are assigned with the same reference characters, and descriptions thereof are omitted.

The anode-side diffusion layer 820B1 provided in the fuel cell 100C of this embodiment is formed so that the gas permeability becomes greater from the upstream side toward the downstream side in the flowing direction of the oxidizing gas, as shown in FIG. 15. In other words, the anode-side diffusion layer 820B1 is formed so that the gas permeability becomes smaller from the downstrea side toward the upstream side in the flowing direction of the oxidizing gas as shown in FIG. 15. Concretely, the anode-side diffusion layer 820B1 is formed so that the porosity becomes greater from the upstream side toward the downstream side in the flowing direction of the oxidizing gas. The porosity herein refers to the porosity of the material of the anode-side diffusion layer 820B1. In this embodiment, the gas permeability of the anode-side diffusion layer 820B1 is changed by changing the porosity. However, this is not restrictive. For example, the gas permeability of the anode-side diffusion layer 820B1 may be changed on the basis of the opening diameter of internal pores of the anode-side diffusion layer 820B1, the material of the anode-side diffusion layer 820B1, or a combination thereof.

Incidentally, in the MEA 24, the generated current becomes smaller from the upstream side toward the downstream side in the flowing direction of the oxidizing gas, in other words, the amount of the fuel gas demanded becomes smaller in the anode 820 from the upstream side toward the downstream side in the flowing direction of the oxidizing gas. Then, in a portion of the anode 820 that corresponds to the downstream side in the flowing direction of the oxidizing gas, there is possibility that the amount of supply of the fuel gas may decrease, and therefore the leak gas partial pressure may heighten, that is, the leak gas may reside. Then, in such a portion, the supply of the fuel gas is more and more restrained, so that there is possibility of decline in the power generation efficiency of the fuel cell 100C.

However, in the fuel cell 100C of this embodiment, since the anode-side diffusion layer 820B1 is formed so that the gas permeability becomes greater from the from the upstream side toward the downstream side in the flowing direction of the oxidizing gas, it is possible to restrain reducing the amount of supply of the fuel gas in a portion of the anode-side diffusion layer 820B1 that corresponds to the downstream side in the flowing direction of the oxidizing gas. Accordingly, in that portion, the decline in the power generation efficiency can be prevented, and therefore the power generation efficiency of the fuel cell 100C can be improved.

### E. Fifth Embodiment

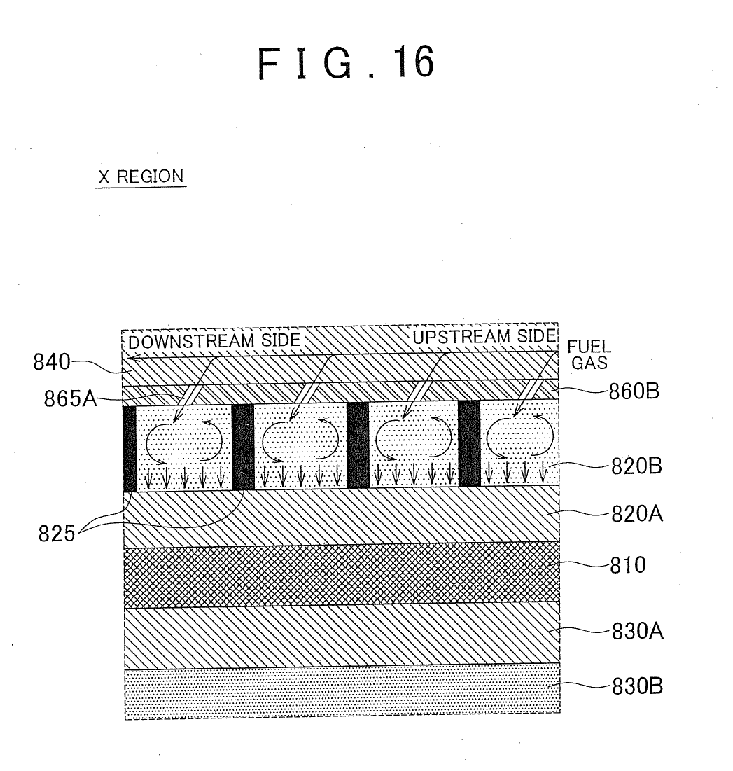

FIG. 16 is an illustrative diagram showing flows of the fuel gas on the anode side in a fuel cell 100D of a fifth embodiment of the invention. The diagram of FIG. 16 corresponds to the drawing of FIG. 11 regarding the fuel cell 100 of the first embodiment: The fuel cell 100D of this embodiment is basically the same in construction as the fuel cell 100 of the first embodiment, but has electroconductive sheets 860B that are different from the electroconductive sheets 860 of the first embodiment. In the fuel cell 100C, portions that are the same in construction as those of the first embodiment are assigned with the same reference characters, and descriptions thereof are omitted.

In each electroconductive sheet 860B provided in the fuel cell 100D of this embodiment, penetration holes 865A are formed so that they are inclined with respect to the thickness direction (stacking direction) of the electroconductive sheet 860B as shown in FIG. 16. In the electroconductive sheet 860B, the penetration holes 865A are arranged in substantially the same manner as the penetration holes 865 of the electroconductive sheet 860 of the first embodiment. With this construction, the fuel gas is introduced into the blocks BL of the anode-side diffusion layer 820B from the anode-side porous body 840 via the penetration holes 865A in a direction inclined with respect to the thickness direction (stacking direction) of the electroconductive sheet 860B. After being introduced into the blocks BL, the fuel gas strikes the partition wall portions 825, and thus easily diffuses within the blocks BL. Therefore, the residence of the leak gas in the blocks BL becomes less likely, and the power generation efficiency of the fuel cell 100D can be improved.

### F. Sixth Embodiment

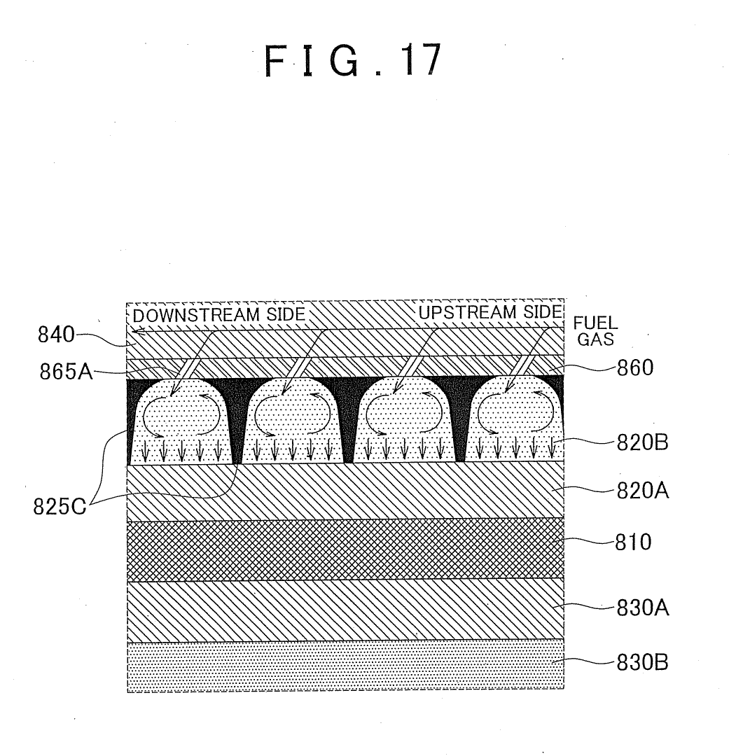

FIG. 17 is an illustrative diagram showing flows of the fuel gas on the anode side of a fuel cell 100E of a sixth embodiment of the invention. The drawing of FIG. 17 corresponds to the drawing of FIG. 16 regarding the fuel cell 100D of the fifth embodiment. The fuel cell 100E of this embodiment is basically the same in construction as the fuel cell 100D of the fifth embodiment, but has partition wall portions 825C that are different from the partition wall portions 825 of the fifth embodiment. Incidentally, in the electroconductive sheet 860B, the arrangement of the penetration holes 865A and the inclination of the penetration holes 865A are substantially the same as those in the electroconductive sheet 860B of the fifth embodiment. In the fuel cell 100E, portions that are the same in construction as those of the fifth embodiment are assigned with the same reference characters, and descriptions thereof are omitted.

The partition wall portions 825C provided in the fuel cell 100E of this embodiment, similar to the partition wall portions 825 of the fifth embodiment, extend from the electroconductive sheet 860B-side surface to the catalyst layer 820A-side surface in the anode-side diffusion layer 820B in the thickness direction (stacking direction) thereof, and divide the anode-side diffusion layer 820B into a plurality of blocks BL as shown in FIG. 17. Concretely, the partition wall portions 825C are formed so that each block BL has a dome shape (a hemispheric shape) with its top portion being on the electroconductive sheet 860B (the side remote from the anode 820). Besides, as shown in FIG. 17, each of the penetration holes 865A of the electroconductive sheet 860 is disposed so as to face a substantially central portion of the electroconductive sheet 860B-side surface of a corresponding one of the blocks BL, and therefore the fuel gas is introduced into the top portions of the blocks BL from the anode-side porous body 840 via the penetration holes 865A. With this arrangement, the fuel gas introduced into the blocks BL easily diffuses in each block BL flowing along the wall surface of the partition wall portion 825C. Therefore, the residence of the leak gas in the blocks BL becomes less likely, and the power generation efficiency of the fuel cell 100E can be improved.

### G. Seventh Embodiment

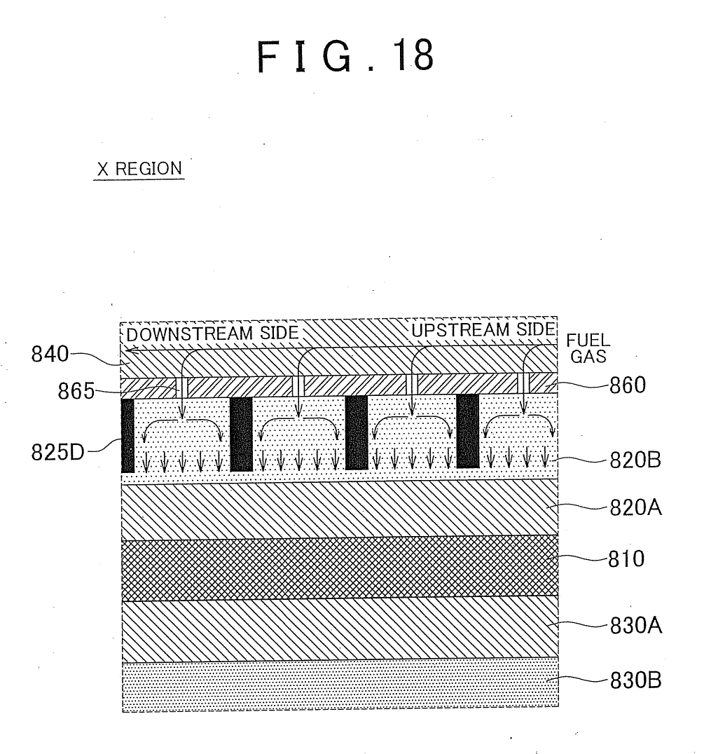

FIG. 18 is an illustrative diagram showing flows of the fuel gas on the anode side of a fuel cell 100F of a seventh embodiment of the invention. The drawing of FIG. 18 corresponds to the drawing of FIG. 11 regarding the fuel cell 100 of the first embodiment. The fuel cell 100F of this embodiment is basically the same in construction as the fuel cell 100 of the first embodiment, but has partition wall portions 825D that are different from the partition wall portions 825 of the first embodiment. In the fuel cell 100F, portions that are the same in construction as those of the first embodiment are assigned with the same reference characters, and descriptions thereof are omitted.

The partition wall portions 825D provided in the fuel cell 100E of this embodiment, as shown in FIG. 18, extend in the anode-side diffusion layer 820B from the electroconductive sheet 860-side surface in parallel with each other in the thickness direction (stacking direction), and divide the anode-side diffusion layer 820B into a plurality of blocks BL, as shown in FIG. 18. In this case, the partition wall portions 825 in the anode-side diffusion layer 820B do not contact the catalyst layer 820A, but remain within the anode-side diffusion layer 820B. Therefore, the partition wall portions 825D can be prevented from damaging the catalyst layers 820A.

### H. Modifications

The invention is not limited to the foregoing embodiments, but may be carried out in various forms without departing from the spirit of the invention.

H1. Modification 1:

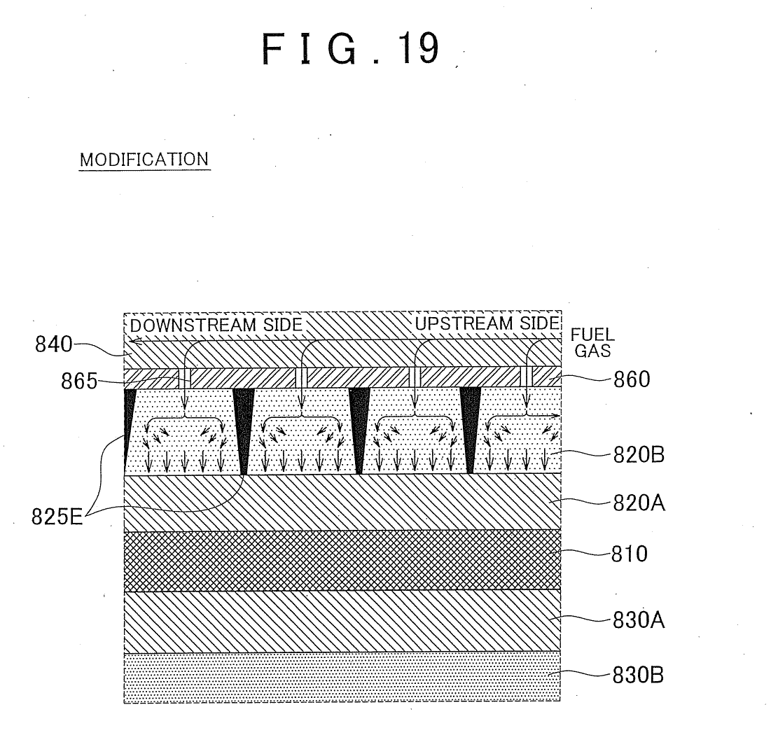

FIG. 19 is a diagram for describing partition wall portions 825E of a fuel cell in Modification 1. Although in the fuel cell 100 of the foregoing embodiment, the partition wall portions 825 are formed extending in the anode-side diffusion layer 820B in a direction parallel to the stacking direction, the invention is not limited to this construction. The partition wall portions 825E in the fuel cell of Modification 1 may be Mulled so that, in an anode-side diffusion layer 820B, the partition wall portions 825E are thinner in the catalyst layer 820A side (the electrolyte membrane 810 side) than in the electroconductive sheet 860 side as shown in FIG. 19. This expands a catalyst layer 820A-side area in each block, so that the fuel gas diffusing in each block BL can be supplied to the catalyst layer 820A in an increased amount. In consequence, the power generation efficiency of the fuel cell improves.

H2. Modification 2:

Although in the individual fuel cells of the foregoing embodiments, the blocks BL divided by the partition wall portion are arranged so as to face a corresponding one of the penetration holes of the electroconductive sheet, the invention is not limited to this construction. For example, the blocks BL divided by the partition wall portion may be arranged so as to correspond to a plurality of the penetration holes 865 of the electroconductive sheet. This will also achieve substantially the same effects as in the fuel cell of the foregoing embodiment.

H3. Modification 3:

Although in the fuel cells of the foregoing embodiments, the opening diameters of the penetration holes of the electroconductive sheet are the same, the invention is not limited to this arrangement. For example, the penetration holes of the electroconductive sheet may be formed so that the opening diameters thereof are larger the greater the relative distance thereof from the oxidizing gas supply slit 440 (i.e., from the oxidizing gas supply openings for supplying the oxidizing gas to the cathode 830), in other words, the shorter the relatively distance from the oxidizing gas discharge slit 444 (i.e. from the oxidizing gas discharge openings for discharging the oxidizing gas from the cathode 830).

H4. Modification 4:

Although in the fuel cells of the foregoing embodiments, the electroconductive sheet used is a gold sheet, the invention is not limited to this construction. For example, the electroconductive sheet may also be foimed from an electroconductive member other than gold, for example, may be formed from titanium, stainless steel, etc. In this case, the electroconductive sheet is joined to one side surface of the anode-side porous body 840 by thermocompression bonding, brazing, welding, or the like.

Furthermore, the electroconductive sheet may be formed from a polymer type electroconductive paste. Examples of this polymer type electroconductive paste include a silver paste, a carbon paste, a silver-carbon paste, etc. In this case, after the polymer type electroconductive paste is formed into a sheet shape, the sheet may be joined to one side surface of the anode-side porous body 840.

H5. Modification 5:

Although the fuel cells of the foregoing embodiments have a closed structure (anode dead-end structure) in which the fuel gas supplied to the anode side is not discharged to the outside, the invention is not limited to this structure. The fuel cell of the invention may also have a mechanism for discharging the fuel gas from the anode 820 side, for example, a fuel gas discharge opening, a fuel gas discharge channel, a fuel gas discharge manifold, etc. Such a fuel cell may also include a shutoff valve capable of shutting off the fuel gas discharged from the fuel gas discharge manifold to the outside of the fuel cell (hereinafter, referred to as the shutoff valve N), and may have an operation mode in which while the shutoff valve N is in the closed state, substantially the entire amount of the fuel gas supplied to the anode-side porous body 840 (the anode side) is caused to be absorbed into and consumed in the anode 820. This construction can also achieve substantially the same effects as the fuel cell 100 of the foregoing embodiments.

H6. Modification 6:

Although in the fuel cells of the foregoing embodiments, the partition wall portions are formed by impregnating the anode-side diffusion layer 820B with a resin, the invention is not limited to this construction. For example, the partition wall portions may also be formed by incorporating a punched metal, a laminated mesh-like member, etc. into the anode-side diffusion layer 820B. This construction can also achieve substantially the same effects as the fuel cells of the foregoing embodiments.

H7. Modification 7:

Although in the anodes 820 of the fuel cells of the embodiments, the partition wall portions are formed only in the anode-side diffusion layer 820B, the invention is not limited to this construction. For example, the partition wall portions may also be fowled not only in the anode-side diffusion layer 820B, but in the catalyst layer 820A as well. With this construction, in the anode-side diffusion layer 820B and the catalyst layer 820A, the fuel gas can be restrained from flowing in the planar directions, and therefore the leak gas can be restrained from locally residing in the anode-side diffusion layer 820B and the catalyst layer 820A (the entire anode 820). In consequence, it becomes possible to supply the fuel gas to the anode 820 in a dispersed fashion.

H8. Modification 8:

Although in each anode 820 of the fuel cells of the foregoing embodiments, the catalyst layer 820A and the anode-side diffusion layer 820B are provided and the partition wall portions are formed in the anode-side diffusion layer 820B, the invention is not limited to this construction. For example, the anode 820 may also be constructed only of the catalyst layer 820A without the anode-side diffusion layer 820B, and the partition wall portions may be formed only in the catalyst layer 820A. With this construction, in the catalyst layer 820A, the fuel gas can be restrained from flowing in the planar directions, and therefore, the leak gas can be restrained from locally residing in the catalyst layer 820A.

Furthermore, in the anodes 820, an electroconductive porous body may further be provided between the catalyst layer 820A and the anode-side diffusion layer 820B. The electroconductive porous body may be a body in which the flow resistance in the planar directions is small, that is, the gas easily flows in the planar directions. With this construction, in the anodes 820, the dispersibility of the fuel gas can be improved.

H9. Modification 9:

Although in the fuel cells of the foregoing embodiments, air is used as the oxidizing gas, the invention is not limited to this construction. For example, it suffices that the oxidizing gas contain oxygen, and a predetermined mixture gas in which a gas other than oxygen has been mixed can be used.

H10. Modification 10:

Although in the fuel cells of the foregoing embodiments, the anode-side diffusion layer 820B is formed from a porous material, the invention is not limited to this construction. It suffices that the anode-side diffusion layer 820B have gas diffusivity; for example, it may be a space. This can also achieve the effects of the foregoing embodiments.

H11. Modification 11:

The fuel cells of the foregoing embodiments are fuel cells of an anode dead-end operation type in which the fuel gas does not need to be circulated by a circulation pump or the like. Thus, space can be saved or the pump power for circulation can be reduced, so that the energy efficiency can be improved. Therefore the fuel cells of the foregoing embodiments are suitable to be mounted in mobile units such as motor vehicles, electric railcars, airplanes, boats and ships, linear motor cars, etc.

H12. Modification 12:

Although the fuel cells of the foregoing embodiments are anode dead-end operation type fuel cells, the invention is not limited to this type of fuel cell, but may also be applied to circulation type fuel cells in which the fuel gas is circulated.

H13. Modification 13:

Although in the fuel cells of the foregoing embodiments, the anode-side diffusion layer 820B is higher in gas permeability than the anode-side porous body 840, the invention is not limited to this construction, that is, it is also permissible that the anode-side porous body 840 be higher in gas permeability than the anode-side diffusion layer 820B. With this construction, the fuel gas easily disperses in the anode-side porous body 840, so that the fuel gas can be supplied to the individual blocks BL in a dispersed fashion.

H14. Modification 14:

Although the fuel cells of the foregoing embodiments are solid polymer type fuel cells, the invention is not limited to this type of fuel cell, but is applicable to various fuel cells such as hydrogen separation membrane type fuel cells, molten carbonate electrolyte type fuel cells, solid oxide type fuel cells, phosphoric acid type fuel cells, etc.

H15. Modification 15:

The fuel cells of the foregoing embodiments adopt a structure in which the fuel gas supplied to the anode 820 is substantially entirely consumed on the anode. As for the channel construction for supplying the fuel gas to the anode 820 which enables the operation in such a structure, various channel constructions can be adopted. Hereinafter, modifications of the construction for supplying the fuel gas to the anode 820 in a shower manner as in the fuel cells of the foregoing embodiments (referred to also as the shower channel type) will be described.

First Modification of Shower Channel:

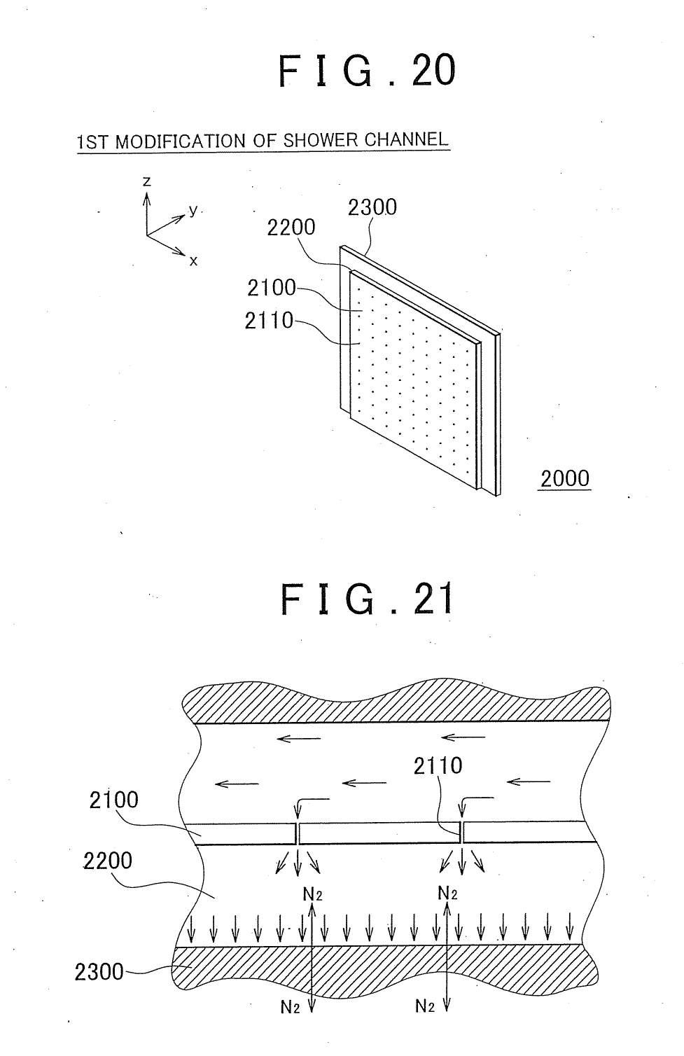

FIG. 20 is an illustrative diagram showing a construction of a first modification of the shower channel. The first modification has a construction in which a dispersion plate 2100 that corresponds to the electroconductive sheet 860 in the foregoing embodiments is formed as being integral with the MEA 2000. The MEA 2000 has an anode 2200 and an electrolyte membrane 2300. Besides, the dispersion plate 2100 is provided with many penetration holes (orifices) 2110 at predetermined intervals.

FIG. 21 is an illustrative diagram illustrating functions of the dispersion plate 2100. The fuel gas is distributed by an upstream-side channel that is isolated by the dispersion plate 2100 from the anode 2200 that consumes the hydrogen gas. The fuel gas distributed into the upstream side channel is locally supplied into the anode 2200, which is a fuel gas consumption layer, through penetration holes 2110 provided in the dispersion plate 2100. That is, in the fuel cell of this modification, the fuel gas is supplied directly to portions of the anode 2200 that correspond to the positions at which the penetration holes 2110 are provided. Examples of the construction that realizes this manner of local supply of the fuel gas include a construction that has a path through which the fuel gas is directly supplied to sites of consumption of the fuel gas without passing through other regions of the anode 2200, or a construction in which the fuel gas is supplied from a direction apart from the plane of the anode 2200 (may be via a channel isolated from the anode 2200) toward the anode 2200, mainly in a perpendicular direction, etc. On the other hand, it suffices that the anode 2200 have a shape in which the residence of nitrogen does not easily occur. For example, it suffices that the anode 2200 be constructed of smooth planes (flat planes), and have a shape that does not have a recess portion or the like on the electrolyte membrane 2300 side.

The diameter and the pitch of the penetration holes 2110 of the dispersion plate 2100 can be empirically determined, and may also be set so that the flow speed of the fuel gas passing through the penetration holes 2110 can sufficiently restrain the diffusion-caused reverse flow of nitrogen gas, for example, in a predetermed operation state (e.g., a rated operation state). It suffices to set the intervals and the channel sectional area of the penetration holes 2110 so as to produce a flow speed or a pressure loss in the penetration holes 2110 that is sufficient to satisfy this condition. For example, with regard to a solid polymer fuel cell, it has been confirmed that a sufficient flow speed or a sufficient pressure loss is produced if the numerical aperture of the dispersion plate 2100 is set at about 1% or less. This numerical aperture is smaller by one to two orders than in the circulation type fuel gas channel, and the construction is essentially different from a construction in which a certain amount of flow of the fuel gas is secured by employing a compressor in a circulation-type fuel gas channel. In this modification, a sufficient amount of the fuel gas is secured despite the structure of a low numerical aperture, by leading the high-pressure hydrogen from the fuel tank directly (or after being adjusted to a predetermined high pressure by a pressure regulating valve) to the fuel cell.

Second Modification of Shower Channel:

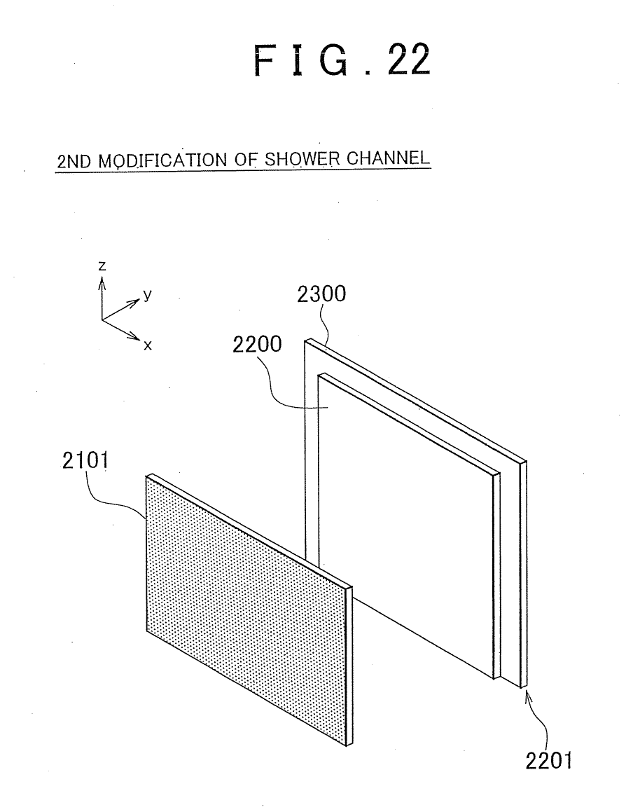

FIG. 22 is an illustrative diagram showing a construction of a second modification of the shower channel. In this modification, a dispersion plate 2101 disposed on an MEA 2201 that has an anode 2200 and an electrolyte membrane 2300 is realized by using a dense porous body. The numerical aperture of the porous body of the dispersion plate 2101 is selected so that a sufficient flow speed or a sufficient pressure loss is produced. In the case where penetration holes (orifices) as shown in conjunction with the first modification are used, the fuel gas is locally supplied to each penetration hole, that is, in a discrete fashion. On the other hand, in the case where a porous body is used, there is an advantage of the fuel gas being able to be continuously supplied. Besides, an advantage of the supply of the fuel gas to the anode 2200 being uniformized can also be obtained. The dense porous body may be manufactured by sintering a carbon powder, or may also be manufactured by fixing a carbon or metal powder with a binding agent. It suffices that the porous body be a continuous porous body. The porous body may have an anisotropy in which continuity in the thickness direction (stacking direction) is secured while continuity in the planar directions is not secured. It suffices that the numerical aperture of the porous body be determined in substantially the same manner as in the first modification of the shower channel.

Third Modification of Shower Channel:

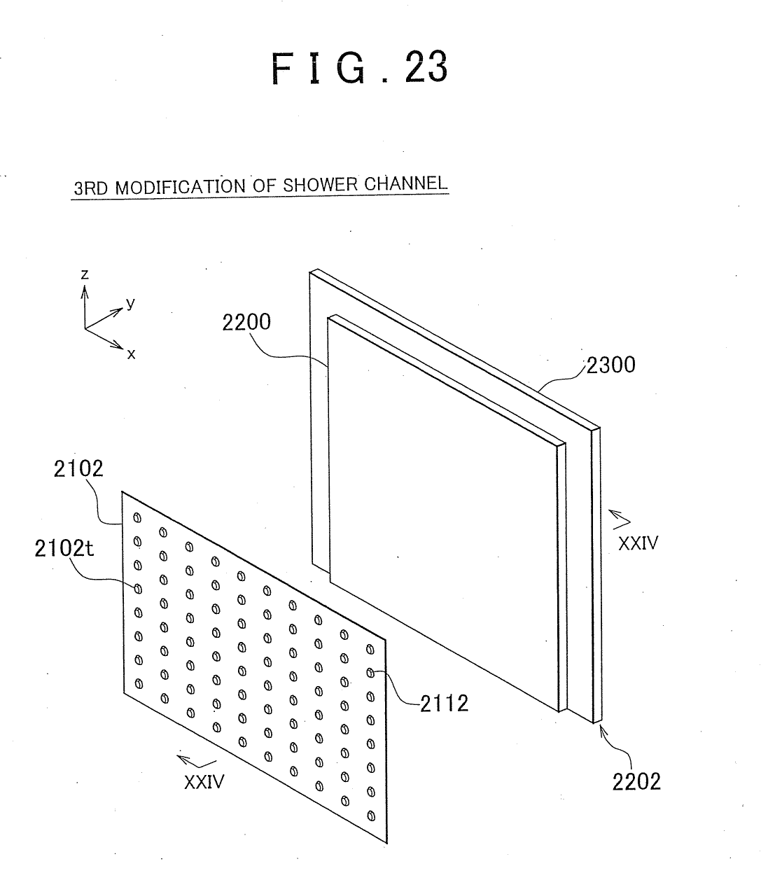

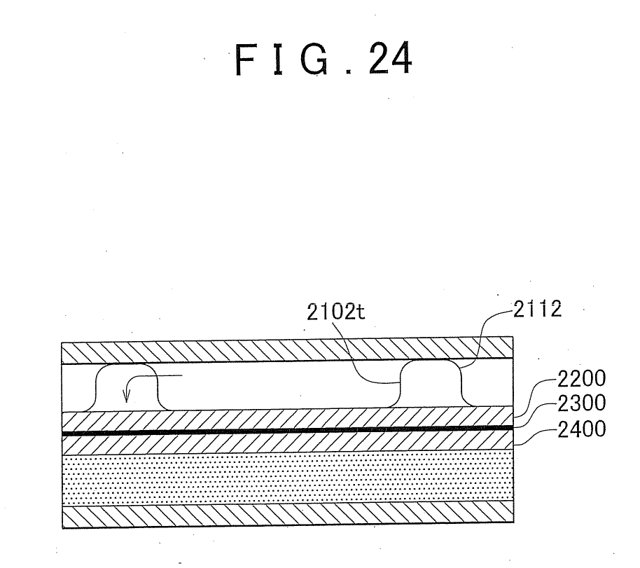

FIG. 23 is an illustrative diagram showing a dispersion plate 2102 constructed by using a pressed metal, as a third modification of the shower channel. FIG. 24 is a schematic diagram showing a section taken on line XXIV-XXIV in FIG. 23. The dispersion plate 2102 is provided with protrusions 2102t for forming a channel on the upstream side of the dispersion plate 2102, and pores 2112 are formed in side surfaces of the protrusions 2102t. In the case where an MEA 2202 has an anode 2200 and a cathode 2400 on opposite sides of the electrolyte membrane 2300, the dispersion plate 2102 is disposed on the anode 2200 side, and the channel on the upstream side of the dispersion plate 2102 is integrally formed by using the protrusions 2102t as shown in FIG. 24. The fuel gas is supplied to the anode 2200 via the pores 2112 formed in the side surfaces of the protrusions 2102t.

According to this construction, the dispersion plate 2102 can easily be formed by a pressing process, and an advantage of the channel upstream of the dispersion plate 2102 being able to be easily formed is obtained. Since the fuel gas that has passed through the pores 2112 reaches the anode 2200 via the internal spaces of the protrusions 2102t, sufficient dispersibility can be secured. The pores 2112 may be formed by a pressing process, or may also be formed by other techniques, such as an electric discharge process or the like, in a processing step preceding or succeeding to the formation of the protrusions 2102t. It suffices that the numerical aperture based on the pores 2112 be determined in substantially the same manner as in the first modification of the shower channel.

Fourth Modification of Shower Channel:

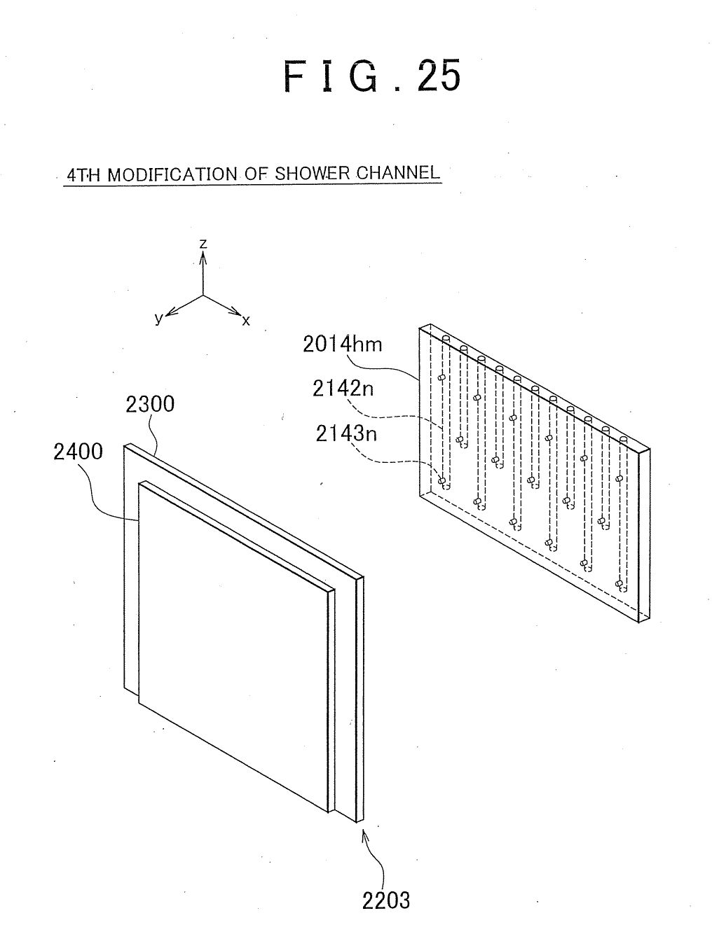

FIG. 25 is an illustrative diagram showing a construction in which channels are formed within a dispersion plate 2014hm, as a fourth modification of the shower channel. The dispersion plate 2014hm in this modification is provided with a plurality of channels 2142n formed in a short-side direction of the dispersion plate 2014hm having a rectangular shape, and many pores 2143n that extend from the channels 2142n in the thickness direction (stacking direction) of the dispersion plate 2014hm and that are opened to the side of an anode (not shown). The dispersion plate 2014hm is disposed on a hydrogen-side electrode side of an MEA 2203 that has a hydrogen-side electrode (not shown) and a cathode 2400 on opposite sides of an electrolyte membrane 2300, and the hydrogen-side electrode is supplied with the fuel gas via the dispersion plate 2014hm. According to this construction, the channels to the pores 2143n can be provided separately for the individual pores 2143n. Incidentally, although the pores 2143n are arranged in a zigzag pattern in FIG. 25, they may also be arranged in a lattice fashion, or may also be arranged in a random fashion to some extent.

Fifth Modification of Shower Channel:

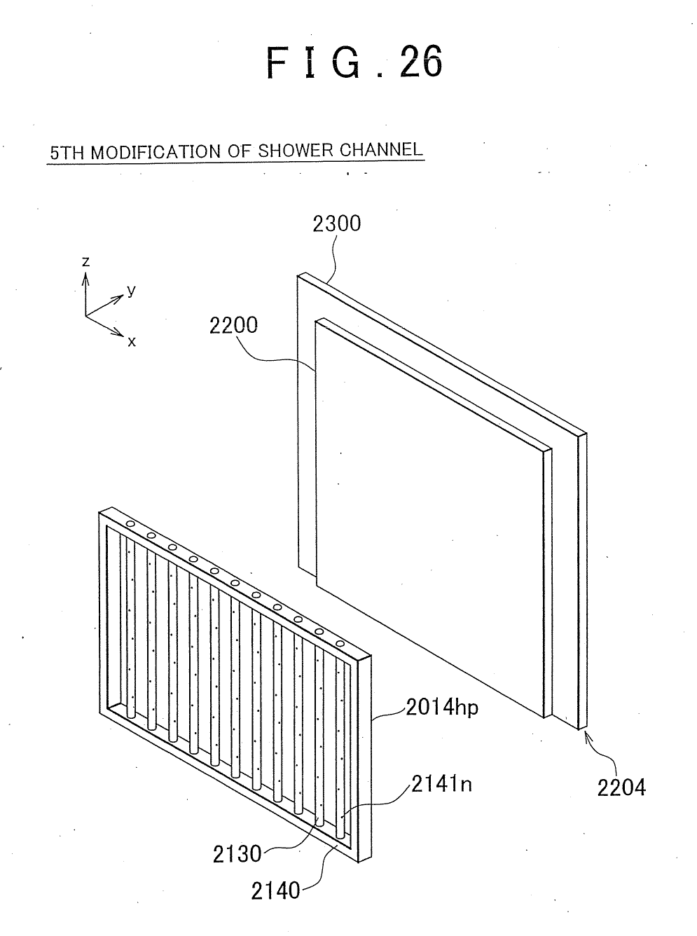

FIG. 26 is an illustrative diagram showing a construction in which a dispersion plate 2014hp is formed by using pipes, as a fifth modification of the shower channel. The dispersion plate 2014hp is provided with a rectangular frame 2140 as shown in FIG. 26, and is also provided with many hollow pipes 2130 that extend in the short-side direction of the rectangular frame 2140. A plurality of pores 2141n are formed in surfaces of the pipes 2130. This dispersion plate 2014hp is disposed on an anode 2200 of an MEA 2204 that includes the anode 2200 and an electrolyte membrane 2300. When the fuel gas is supplied through gas inflow openings formed in the frame 2140 of the dispersion plate 2014hp, the fuel gas passes through the interior of each pipe 2130 of the dispersion plate 2014hp, and is distributed to the anode 2200 through the pores 2141n. According to this construction, an advantage of there being no need to perform a hole-forming process in members or the like other than the pores 2141n in order to construct the dispersion plate 2014hp can be obtained, in addition to being able to uniformly disperse the fuel gas. The pores 2141n may be disposed toward the anode 2200 side, or may also be disposed toward the opposite side. In the latter case, the dispersibility of the fuel gas is further bettered.

As described above, various constructions can be adopted as long as a structure in which the fuel gas is guided while the anode 2200 is being dispersed is provided. The dispersion plate is not limited to a porous body or a pressed metal, but may be made of any material as long as the dispersion plate is constructed so as to guide the fuel gas to the anode 2200 while dispersing the fuel gas.

H16. Modification 16:

Although in the fuel cells of the foregoing embodiments, the fuel gas supply channel is a porous body type channel formed by using a porous body, the fuel gas supply channel may have various configurations. Hereinafter, modifications of the fuel gas supply channel will be described.

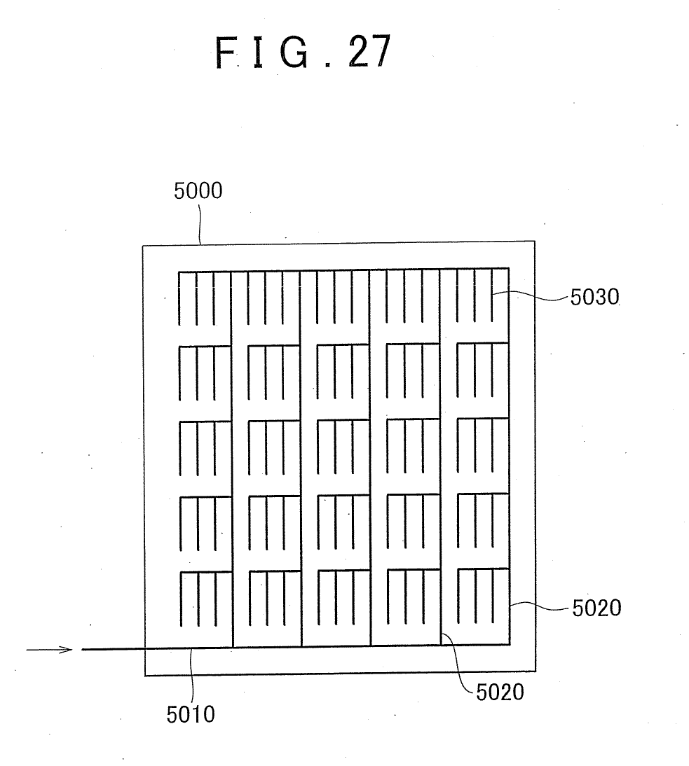

FIG. 27 is a schematic diagram showing a construction example that employs a so-called branch channel type fuel gas supply channel is employed. The fuel gas supply channel shown is formed in a comb shape in a channel-forming member 5000 that is used instead of the anode-side porous body 840 in the fuel cells of the foregoing embodiments. Concretely, the fuel gas supply channel is formed by a main channel 5010 that introduces the fuel gas, a plurality of subsidiary channels 5020 that are formed in a direction that intersects with the main channel 5010, and comb-tooth channels 5030 further branching from the subsidiary channels. The main channel 5010 and the subsidiary channels 5020 have sufficient channel sectional areas as compared with the distal-end comb-tooth channels 5030. Therefore, the pressure distribution in the surface of the channel-forming member 5000 is substantially the same as or less than in the anode-side porous body 840.

This channel-forming member 5000 can be formed by using a carbon, a metal, etc. In the case where a carbon is used, the channel-forming member 5000 provided with channels as shown in FIG. 27 can be obtained by sintering the carbon powder at high temperature or low temperature in a mold. In the case where a metal is used, the channel-foiuiing member 5000 provided with channels as shown in the drawing may be obtained by cutting grooves in a metal plate, or may also be obtained by a pressing process. In addition, the channel-forming member 5000 does not need to be provided as a separate piece, but may also be formed integrally with another member, for example, a separator or the like.

Incidentally, this channel-forming member 5000 may be used instead of the entire anode-side porous body 840, or may also replace the anode-side porous body 840 and the electroconductive sheet 860 combined. In this case, it suffices that the comb-tooth channels 5030 be sufficiently narrow channels and a great number of them be branched from the subsidiary channels 5020 finely, that is, in the fashion of capillary vessels. Besides, in FIG. 27, the main channel 5010 is provided along one side edge portion of the channel-forming member 5000. However, in order to lessen the pressure difference of the fuel gas in the plane of the channel-forming member 5000, the main channel 5010 may be provided along a plurality of edge portions and the length of the subsidiary channels 5020 may be shortened, or the main channel 5010 may be provided in the middle of the channel-forming member and the subsidiary channels 5020 may be disposed on the left and right side (two opposite sides) of the main channel 5010. Likewise, the comb-tooth channels 5030 may also be provided on two opposite sides of the subsidiary channels 5020.

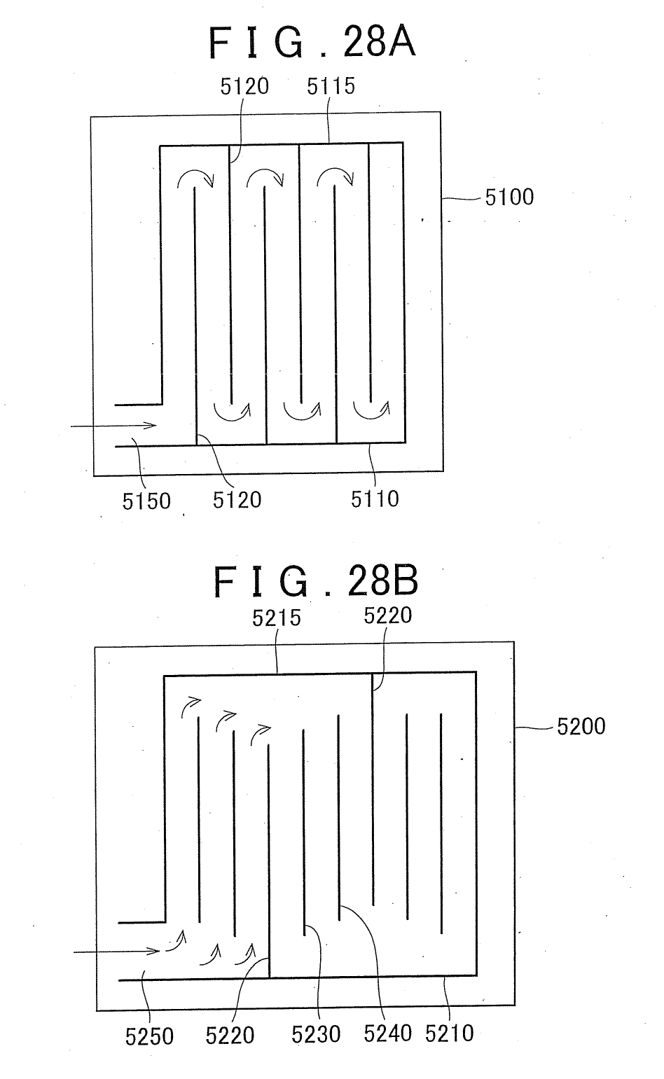

Next, with reference to FIGS. 28A and 28B, a serpentine channel construction will be described. FIGS. 28A and 28B are schematic diagrams schematically showing construction examples of a channel-forming member provided with serpentine channel having a zigzag channel shape. FIG. 28A shows an example of a channel-forming member 5100 that has a single channel for the fuel gas, and FIG. 28B shows an example of a channel-forming member 5200 in which a plurality of fuel gas channels are integrated.

As shown in FIG. 28A, the channel-forming member 5100 has a plurality of channel walls 5120 that extend inward alternately from two opposite outer walls 5110, 5115 of the outer walls that surround the fuel gas channel. Portions partitioned by the channel walls 5120 form a continuous channel. At an end of the channel, an inflow opening 5150 is fanned, and the fuel gas is supplied into the channel via the inflow opening 5150. This channel-forming member 5100, similar to the channel-forming member 5000 shown in FIG. 27, is used in place of the anode-side porous body 840 of the foregoing embodiments.

FIG. 28B shows an example in which the serpentine channel is constructed as a bundle of channels. In this case, the partition walls 5230, 5240 that are not connected to the outer walls are provided between a plurality of channel walls 5220 that extend inward alternately from the two opposite outer walls 5210, 5215. Besides, an inflow opening 5250 is formed at an inlet opening of the channel. The fuel gas that has flown in via the inflow opening 5250 flows through the wide serpentine channel provided with the partition walls 5230, 5240, spreading to every portion of the channel-forming member 5200 in the planar directions. This channel-forming member 5200, similar to the channel-forming member 5000 shown in FIG. 27, is used in place of the foregoing porous body 840.

The channel-forming member 5100 shown in FIG. 28A and the channel-forming member 5200 shown in FIG. 28B are formed from a carbon or a metal, similarly to the channel-forming member 5000 having a comb-shape channel shown in FIG. 27. The forming method for the channel-forming members 5100, 5200 is also substantially the same as that for the channel-forming member 5000. The channel-forming members 5100, 5200 do not need to be provided as separate pieces, but may also be formed integrally with another member, for example, a separator or the like.

H17. Modification 17:

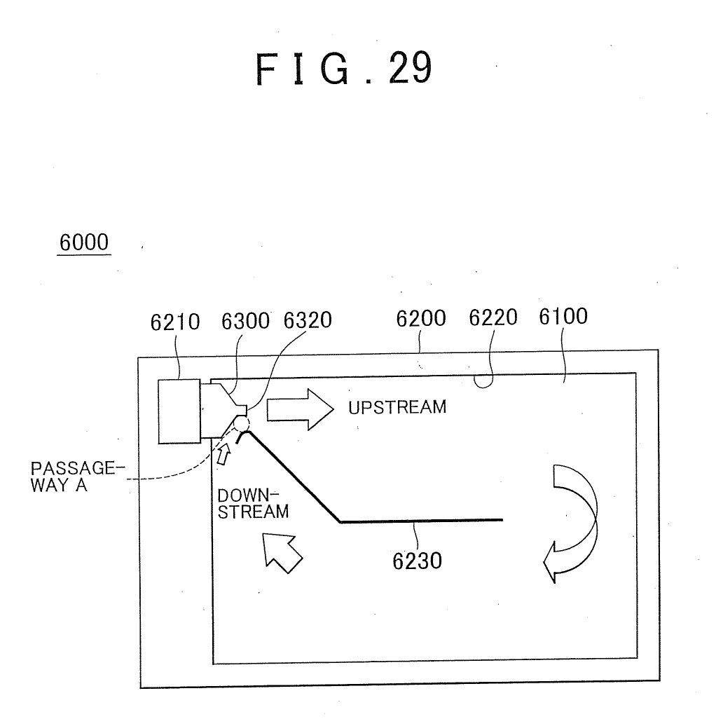

FIG. 29 is an illustrative diagram schematically showing an internal construction of a circulation path-type fuel cell 6000, as a modification of the fuel gas supply channel. As shown in FIG. 29, in the fuel cell 6000 of this modification, an anode-side separator 6200 is provided with a recess portion 6220 that forms a fuel gas supply channel, a fuel gas inlet port 6210, and a restriction plate 6230. The recess portion 6220 that form a fuel gas supply channel is formed entirely in a region that faces an anode 6100 of the anode-side separator 6200. A nozzle 6300 is attached to the fuel gas inlet port 6210 of the anode-side separator 6200 so that the nozzle 6300 can jet the fuel gas toward the recess portion 6220. As the fuel gas is jetted from the nozzle 6300; the fuel gas is supplied from the fuel gas inlet port 6210 into the recess portion 6220. The restriction plate 6230 is a member that restricts the flowing direction of the fuel gas, and stands from a bottom surface of the recess portion 6220, extending from the vicinity of the nozzle 6300 to a neighborhood of the center of the recess portion 6220. An end portion of the restriction plate 6230 that is close to the nozzle 6300 is curved in conformation with the shape of a side surface of the nozzle 6300, and a passageway A is defined between the end portion of the restriction plate 6230 and the nozzle 6300.

In this fuel cell 6000, when the fuel gas supplied from the fuel gas inlet port 6210 is injected from an injection hole 6320 of the nozzle 6300 into a fuel gas supply channel (recess portion 6220), the fuel gas is restricted in the flowing direction by the inner-side walls of the recess portion 6220 of the anode-side separator 6200 and by the restriction plate 6230, so that the fuel gas flows from the upstream side to the downstream side along the surface of the anode 6100, as shown by hollow arrows in FIG. 29. At this time, due to the ejector effect brought about by the high-speed fuel gas jetted from the nozzle 6300, a fluid containing the leak gas (inert gas) and the fuel gas on the downstream side is drawn into a gap (passageway A) that is provided between the end portion of the restriction plate 6230 and the nozzle 6300, and is circulated to the upstream side. In this manner, the residence of the fluid in the fuel gas supply channel and on the surface of the anode 6100 can be restrained.

Incidentally, although in the fuel cell 6000 of the foregoing modification, the fluid is circulated in directions along the surface of the anode 6100 by utilizing the ejector effect, any other construction may also be employed as long as it is a construction in which the fluid can be circulated in directions along the surface of the anode within the fuel cell. For example, in the fuel cell 6000, a rectifier plate is provided at a site that can form a fuel gas supply channel, such as a site in the surface of the anode 6100, the anode-side separator 6200, etc., instead of the nozzle 6300 or the restriction plate 6230, and the fluid may be circulated in directions along the surface of the anode 6100 by this rectifier plate and the flow of the fuel gas. Alternatively, a small actuator (e.g., a micro-machine) may be incorporated along a circulation path within a gas channel, such as the recess portion 6220 or the like, to form a structure that causes the fuel gas to circulate. Furthermore, a construction in which a temperature difference is provided within the recess portion 6220 and the convection is utilized to cause the circulation is also conceivable.

H18. Modification 18:

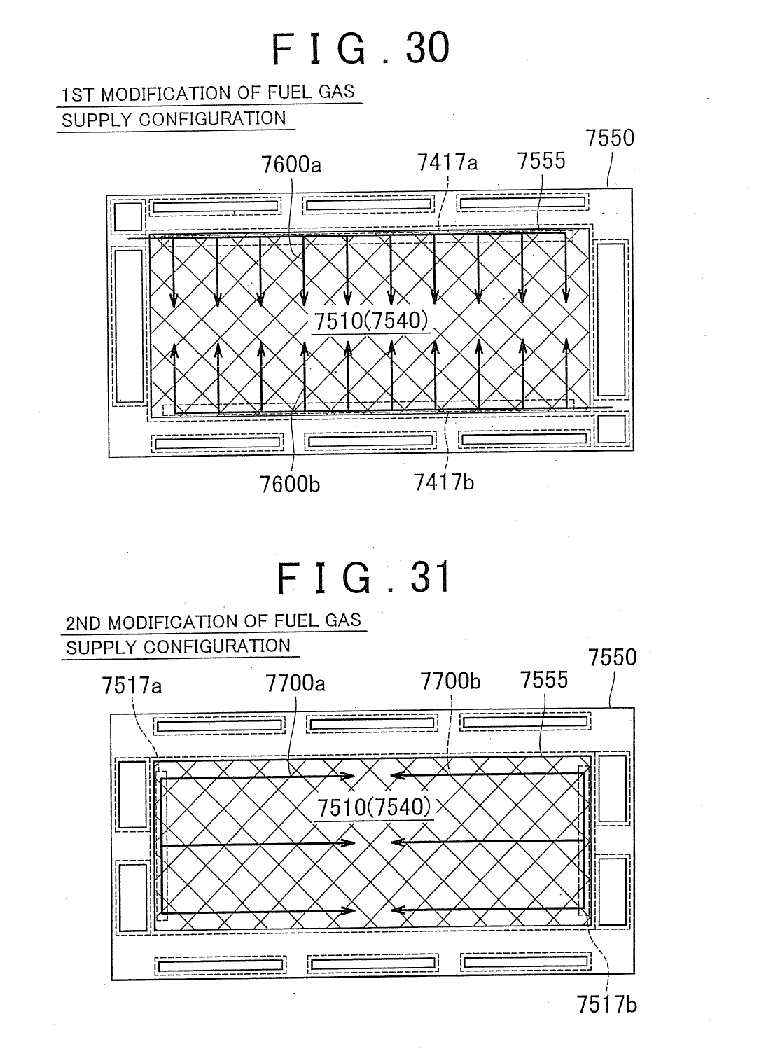

Using FIG. 30 and FIG. 31, a modification of the fuel gas supply configuration in the fuel cells of the foregoing embodiments will be described. FIG. 30 is an illustrative diagram illustrating flows of the fuel gas as a first modification of the fuel gas supply configuration. FIG. 31 is an illustrative diagram illustrating flows of the fuel gas as a second modification of the fuel gas supply configuration. Firstly, constructions common to the two modifications will be described. In these two fuel cells, the electric power generator includes a frame 7550, an MEA7510, and an anode-side porous body 7540. A central portion of the frame 7550 is provided with an opening portion 7555 for fitting the MEA7510 in, and the MEA7510 is disposed so as to cover the opening portion 7555. The anode-side porous body 7540 is disposed on the MEA7510. Besides, a plurality of penetration holes through which the fuel gas, air or a cooling water passes are provided in an outer peripheral portion of the frame 7550, which is the same as in the foregoing embodiments.

The first modification and the second modification of the fuel gas supply configuration are different from the foregoing embodiments in that in the anode-side porous body, the fuel gas is supplied from two directions. The first and second modifications of the fuel gas supply configuration are substantially the same in the overall construction, and are the same in that the fuel gas is supplied to a separator (not shown), but are different from each other in the direction of supply of the fuel gas to the anode-side porous body 7540. In the first modification of the fuel gas supply configuration, as shown in FIG. 30, a fuel gas supply slit 7417a for supplying the fuel gas to the anode-side porous body 7540 is provided in the vicinity of a long side edge portion, among the outer edge portions of the opening portion 7555 of the frame 7550, and another fuel gas supply slit 7417b is disposed in the vicinity of the other long side edge that is opposite to the foregoing long side edge. On the other hand, in the second modification, as shown in FIG. 31, fuel gas supply slits 7517a, 7517b are disposed adjacent to two opposite short sides of the opening portion 7555.

In the first modification of the fuel gas supply configuration, the fuel gas is supplied through the fuel gas supply slit 7417a or the fuel gas supply slit 7417b into the anode-side porous body 7540, flowing from the long side end portion sides toward a middle portion of the anode-side porous body 7540, that is, in the direction of arrows 7600a (downward from a top in FIG. 30) or in the direction of arrows 7600b (upward from a bottom in FIG. 30). Thus, the fuel gas supplied into the anode-side porous body 7540 through the fuel gas supply slit 7417a and the fuel gas supplied into the anode-side porous body 7540 through the fuel gas supply slit 7417b collide and mix with each other near the middle portion of the module. On the other hand, in the second modification of the fuel gas supply configuration, the fuel gas is supplied through the fuel gas supply slit 7517a or the fuel gas supply slit 7517b into the anode-side porous body 7540, flowing from the short side end portion sides toward a middle portion of the anode-side porous body 7540, that is, in the direction of arrows 7700a (from left to right in FIG. 31) and in the direction of arrows 7700b (from right to left in FIG. 31). In the second modification of the fuel gas supply configuration, too, the fuel gas supplied to the anode-side porous body 7540 through the fuel gas supply slit 7517a and the fuel gas supplied to the anode-side porous body 7540 through the fuel gas supply slit 7517b collide and mix with each other near the middle portion of the module.

According to the first and second modifications of the fuel gas supply configuration, the fuel gas is supplied to the anode-side porous body 7540 in two opposite directions from the fuel gas supply slits 7417a, 7417b (or the fuel gas supply slits 7517a, 7517b) that are provided near two opposite side end portions of the anode-side porous body 7540. The opposing flows of the fuel gas thus supplied collide and mix with each other at a middle portion of the anode-side porous body 7540. Therefore, an advantage of the leak gas (inert gas) being unlikely to be localized can be achieved. Hence, the power generation efficiency of the fuel cell can be improved. Also, since the fuel gas is supplied from two opposite sides, an advantage of the distribution of the fuel gas being restrained from deviating from a desired one within the anode-side porous body 7540 can be achieved. Incidentally, although the first and second modifications of the fuel gas supply configuration employ a porous body as the fuel gas supply channel, the fuel gas supply channel is not limited to a porous body, but various other supply methods described below may be used.

H19. Modification 19:

A startup-time control of the fuel cells of the foregoing embodiments will be described. In a fuel cell in accordance with this modification, when the fuel cell is started up, the supply of the fuel gas to the anode-side fuel gas channel is started, and it is only after a predetermined time TA elapses that a load is connected to the fuel cell and current is extracted from the fuel cell. Due to this operation, the leak gas (nitrogen gas or an inert gas) having leaked from the cathode side to the anode side and having been residing therein following the end of the power generation of the fuel cell is pushed back to the cathode side by the pressure of the fuel gas during the predetermined time TA. Hence, after the amount of the leak gas residing in the anode side has decreased, a load is connected to the fuel cell. Therefore, it is possible to restrain the occurrence of a situation that at the startup of the fuel cell, the fuel is operated while the fuel gas is lacking in the anode 820. Incidentally, the “startup” herein means to supply the reaction gases (the fuel gas and the oxidizing gas) to the fuel cell and connect a load to the fuel cell. A reason why the leak gas resides in the anode side during a stop of the fuel cell is that as a result of the stop of the supply of the fuel gas, the fuel gas pressure in the anode side declines. In particular, in the case where an anode dead-end construction is adopted, the discharge of the leak gas to a discharge path by the supply of the fuel gas cannot be expected. Therefore, it is effective to secure a sufficient time TA following the start of the supply of the fuel before a load is connected to the fuel cell.

It is also possible to adopt a construction in which, at the time of startup of the fuel cell, at least one of the amount of supply of the fuel gas and the predetermined time TA prior to the connection of an electrical load to the fuel cell is determined on the basis of the amount of the leak gas residing at the starting time of operation of the fuel cell. This leak gas residence amount may be estimated, for example, from the temperature of the fuel cell or the duration of the stop of the fuel cell from the previous end of the startup to the present startup of the fuel cell. The temperature of the fuel cell can be detected, for example, on the basis of the temperature of the coolant that cools the fuel cell. This will decrease the leak gas residence amount in the anode-side fuel gas channel while realizing a shortened startup time of the fuel cell.

Furthermore, the timing of connecting a load to the fuel cell at the time of startup thereof may be determined the basis of the hydrogen concentration on the anode side. In the fuel cells of the foregoing embodiments, a hydrogen concentration sensor is attached to a predetermined site in the anode-side fuel gas channel. At the time of startup of the fuel cell, the hydrogen concentration value detected by the hydrogen concentration sensor after the supply of the fuel gas to the anode-side fuel gas channel starts is monitored. If an electrical load is connected to the fuel cell after the hydrogen concentration value becomes higher than a predetermined threshold value, the operation with hydrogen lacking on the anode 820 can be restrained. Besides, it is also possible to adopt a construction in which the timing at which an electrical load is connected to the fuel cell is found from the anode-side pressure or temperature.

The fuel cells described above in conjunction with the embodiments include, as the mode of operation performed by supplying the fuel gas, a mode in which substantially the entire amount of fuel gas supplied is consumed on the anode. The term “substantially the entire amount of fuel gas supplied is consumed” herein means that the fuel gas is not used in a manner in which the fuel gas is actively extracted from the anode and is circulated in the fuel gas supply path. The consumption of the fuel gas includes the use thereof in the electrochemical reactions for power generation, but also the permeation thereof through the electrolyte membrane to the opposite side. Besides, the leak that occurs in a fuel cell that is constructed in reality may also be included in the consumption. The power generation performed in a fuel cell while the fuel gas is used as described above is called dead-end operation. This operation can be understood as a mode of operation in which the fuel gas is substantially entirely used for power generation while the fuel gas is not discharged to the outside but is residing within the fuel gas. Accordingly, this means that the anode supplied with the fuel gas generally has a closed structure in which the fuel gas is not discharged or released.

The operation of the fuel cell performed by supplying the fuel gas to the anode side of the power generator is called the anode dead-end operation. In the anode dead-end operation, the electric power generation is continued in a state where the fuel gas is not discharged from the anode side while the supply of the fuel gas to the anode side is continued. Accordingly, the power generation is performed while substantially the entire amount of the fuel gas supplied is held on the anode side at least during a steady power generation. In the case where the power generator includes an MEA (membrane-electrode assembly) formed by joining an anode and a cathode to two opposite surfaces of an electrolyte membrane, and generates electric power by supplying the fuel gas (hydrogen or a hydrogen-containing gas in most cases) to the anode side, substantially the entire amount of the fuel gas supplied to the anode is utilized for the power generation while being caused to reside inside without being discharged to the outside. Accordingly, this means that the anode side supplied with the fuel gas generally has a closed structure in which the fuel gas is not discharged or released.

In the foregoing embodiments, the mode of operation in which substantially the entire amount of the fuel gas supplied to the fuel gas-consuming layer (anode) is consumed on the fuel gas consumption layer is called the dead-end operation. Even if such a construction is provided with an added Rhin in which the circulation of the fuel gas from the fuel gas consumption layer is not intended but the fuel gas is nominally extracted for use from the fuel gas consumption layer, this whole construction is included in the dead-end operation. For example, it is possible to conceive a construction in which a channel for extracting a small amount of the fuel gas from the fuel gas consumption layer or an upstream side thereof is provided and the extracted gas is burned to pre-heat accessories and the like. Such nominal consumption of the fuel gas is not a construction that is to be excluded from the “consumption of substantially the entire amount of the fuel gas by the fuel gas consumption layer” in the foregoing embodiments unless there is a special meaning with the extraction of the fuel gas from the fuel gas consumption layer or the upstream side thereof.

The fuel cells in accordance with the foregoing embodiments can also be grasped as fuel cells that realize the operation state in which the power generation is continuously performed in a state in which the partial pressure of an impurity (e.g., nitrogen) in the anode (or the hydrogen electrode) is in balance with the partial pressure of an impurity (e.g., nitrogen) of the cathode (or the air electrode). Incidentally, the term “in balance” means, for example, an equilibrium state, and is not limited to the state in which the two partial pressures are equal.

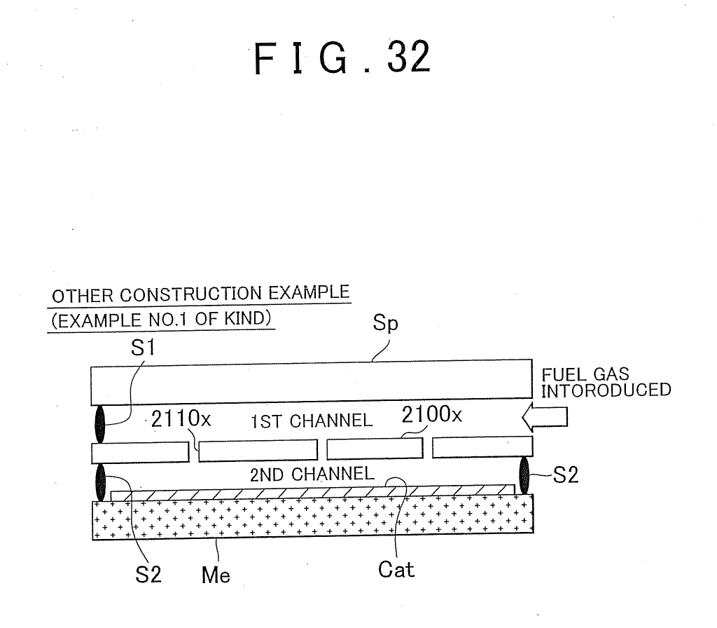

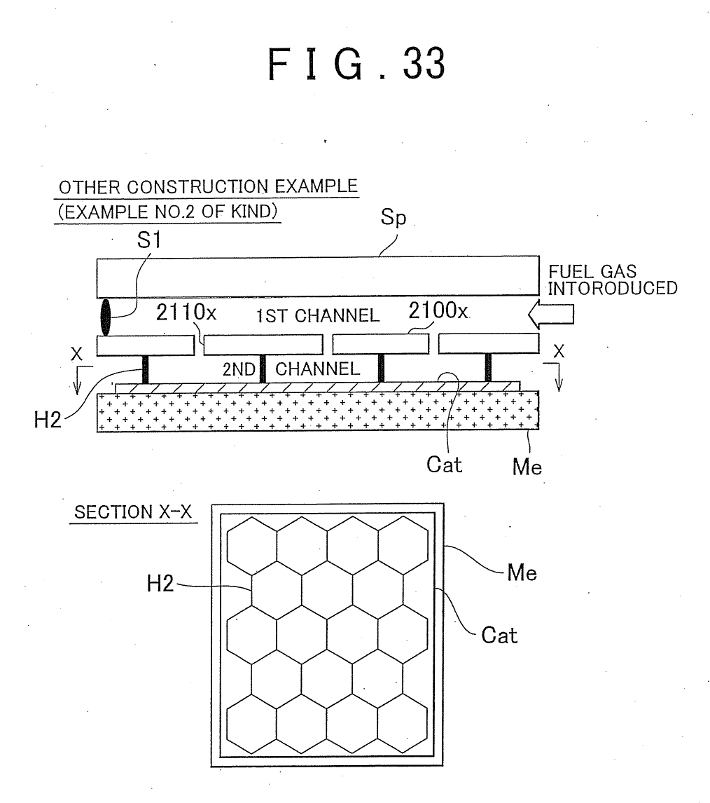

The fuel cells in accordance with the foregoing embodiments include constructions as shown in FIGS. 32 and 33. The construction example shown in FIG. 32 has a first channel and a second channel through which the fuel gas flows. The first channel is disposed on an upstream side of the second channel. The first channel and the second channel are linked in communication via a high-resistance communication portion 2100x that is higher in flow resistance than the first channel or the second channel. These channels introduce the fuel gas from outside the power generation portion plane (the outside of the fuel cell) via a fuel gas introduction opening (e.g., manifold). In other words, the supply of the fuel gas into the second channel is introduced from the first channel mainly via the high-resistance communication portion 2100x (e.g., via only the high-resistance communication portion 2100x).

Although the first channel and the second channel can be formed by utilizing a porous body as in the foregoing embodiments, the channels may also be constructed, for example, as a channel configuration sandwiched by seal members S1, S2 (FIG. 32) or a channel configuration that employs a honeycomb structural member H2 (FIG. 33).

The high-resistance communication portion 2100x used herein can be a platy member in which a plurality of introduction portions 2110x (penetration holes) are dispersed in in-plane directions as shown in FIG. 32 or FIG. 33. The high-resistance communication portion 2100x performs at least one of the following roles: The first role is a “role of restricting the supply of the fuel gas to a region in the second channel that is adjacent to the fuel gas introduction opening”. The second role is a “role of restraining the nonuniformity of the gas pressures in the plane of the second channel along the anode reaction portion that act thereon in the perpendicular-to-plane direction”. The third role is a “role of converting the direction of the fuel gas flowing in in-plane directions in the first channel into the perpendicular-to-plane direction (or a direction intersecting with the plane)”.

Furthermore, the fuel cells in accordance with the foregoing embodiments may also be grasped as the following fuel cell system. Specifically, this fuel cell system is a fuel cell system that includes a mode in which substantially the entire amount of a fuel gas supplied is consumed in an anode reaction portion, and includes an introduction opening that introduces an anode gas into a power generation cell, a first gas channel leading the anode gas supplied from the introduction opening into in-cell-plane directions, and a high-resistance portion that extends along the anode reaction portion, and that is higher in flow resistance than the first gas channel, and that leads the anode gas from the first gas channel to a second gas channel via a plurality of communication portions distributed in the in-cell-plane directions while preventing the inflow of the anode gas from the first gas channel to the second gas channel.

The fuel cells of the foregoing embodiments can also be grasped as a fuel cell system that includes the following construction. Specifically, this fuel cell system may have a construction in which the high-resistance portion has one communication portion that corresponds to one region in the anode reaction portion, and another communication portion that corresponds to another region in the anode reaction portion, and in which, in the anode gas consumed in the one region, the proportion of the gas that has passed through the one communication portion in the high-resistance portion is higher than the proportion of the gas that has passed through the another communication portion, or a construction in which the high-resistance portion has one communication portion that corresponds to one region in the anode reaction portion, and another communication portion that corresponds to another region in the anode reaction portion, and in which, in the anode gas that has passed through the one communication portion, the proportion of the gas that is consumed in the one region in the anode reaction portion is higher than the proportion of the gas that is consumed in the another region in the anode reaction portion.

The cathode channel, on the other hand, may have a construction in which at least the high-resistance communication portion is omitted. Furthermore, the cathode channel may be provided with only a first gas channel that leads the cathode gas supplied from the cathode introduction opening in in-cell-plane directions, without the second channel. However, if the so-called gas diffusion layer is considered as a second channel, the cathode channel may be a combination of the first and second channels. In any case, due to the omission of the high-resistance communication portion only from the cathode electrode, the amount of work of the cathode gas feeder can be expected to decrease and the drainage characteristic at the cathode electrode can be expected to improve. Thus, the foregoing construction is particularly suitable in a system in which the performance of drainage from the anode electrode is low (there is no steady discharge of the fuel gas).

The invention is not limited to the fuel cells in accordance with the foregoing embodiments, but can also be realized in other manners of device invention. Besides, the invention can also be realized in manners as a method invention, such as a production method for a fuel cell, or the like.

While the invention has been described with reference to what are considered to be preferred embodiments thereof, it is to be understood that the invention is not limited to The disclosed embodiments or constructions. On the contrary, the invention is intended to cover various modifications and equivalent arrangements. In addition, while the various elements of the disclosed invention are shown in various combinations and configurations, which are exemplary, other combinations and configurations, including more, less or only a single element, are also within scope of the invention.

1. A fuel cell comprising:
an electrolyte membrane;
an anode-forming layer that is provided on an outer side of one surface of the electrolyte membrane and that includes an anode;
a cathode provided on an outer side of another surface of the electrolyte membrane; and
a gas introduction portion for introducing a fuel gas into the anode-forming layer,
wherein the anode-forming layer is provided with a partition wall portion that is formed in a thickness direction of the anode-forming layer from a side of the anode-forming layer opposite to a side of the anode-forming layer where the electrolyte membrane is located, and that divides at least a portion of the anode-forming layer into a plurality of blocks, and that restrains movement of a gas between adjacent ones of the blocks, and
wherein the gas introduction portion has a gas passage portion that allows the fuel gas to pass through, and introduces the fuel gas into the blocks via the gas passage portion in a direction perpendicular to the planar direction of the anode-forming layer or inclined with respect to the thickness direction of the anode-forming layer.

2. The fuel cell according to claim 1, wherein the plurality of blocks are arranged so that one block corresponds to one gas passage portion.

3. The fuel cell according to claim 1, wherein the partition wall portion divides at least a portion of the anode-forming layer in a lattice fashion.

4. The fuel cell according to claim 1, wherein the partition wall portion divides at least a portion of the anode-forming layer in a honeycomb fashion.

5. The fuel cell according to claim 1, further comprising an oxidizing gas channel-forming portion that is provided on an outer side of the cathode and that forms an oxidizing gas supply channel for supplying an oxidizing gas in a direction along a surface of the cathode,
wherein a block that corresponds to an upstream side in a flowing direction of the oxidizing gas that flows in the oxidizing gas supply channel has a smaller volume than a block that corresponds to a downstream side in the flowing direction.

6. The fuel cell according to claim 1, further comprising an oxidizing gas channel-forming portion that is provided on an outer side of the cathode and that forms an oxidizing gas supply channel for supplying an oxidizing gas in a direction along a surface of the cathode,
wherein a block that corresponds to a downstream side in a flowing direction of the oxidizing gas that flows in the oxidizing gas supply channel has a greater gas permeability than a block that corresponds to an upstream side in the flowing direction.

7. The fuel cell according to claim 1, wherein the partition wall portion is formed so that each block has a dome shape whose top portion faces in a direction away from a side of the anode where the electrolyte membrane is located.

8. The fuel cell according to claim 1, wherein the partition wall portion is formed so as to be thinner at a side of the anode-forming layer that is relatively close to the electrolyte membrane than at a side of the anode-forming layer that is relatively remote from the electrolyte membrane.

9. The fuel cell according to claim 1, wherein the anode-forming layer includes a catalyst layer and a gas diffusion layer in that order from a side of the anode-forming layer that is relatively close to the electrolyte membrane, and the partition wall portion is formed at least in the gas diffusion layer.

10. The fuel cell according to claim 1, wherein the partition wall portion is formed in the gas diffusion layer without contacting the catalyst layer.

11. The fuel cell according to claim 1, wherein:
the gas introduction portion is an electroconductive sheet portion having a sheet shape and being gas-impermeable which is provided on a side of the anode-forming layer that is remote from the electrolyte membrane;
the gas passage portion is a plurality of penetration holes that are arranged in a dispersed fashion along a sheet plane of the electroconductive sheet portion; and
the fuel cell further comprises a fuel gas channel-forming portion which is provided on a side of the electroconductive sheet portion that is remote from the anode-forming layer and which forms a fuel gas supply channel for supplying the fuel gas in a direction along a plane of the electroconductive sheet portion.

12. The fuel cell according to claim 1, wherein the anode is lower in gas permeability than the fuel gas supply channel that is formed by the fuel gas channel-forming portion.

13. The fuel cell according to claim 11, wherein the penetration holes provided in the electroconductive sheet portion are inclined with respect to a thickness direction of the electroconductive sheet portion.

14. The fuel cell according to claim 1, wherein:
the gas introduction portion is a pipe-shape member through whose interior the fuel gas passes; and
the gas passage portion is a plurality of penetration holes that are arranged in a dispersed fashion in the pipe-shape member.

15. The fuel cell according to claim 1, wherein the gas introduction portion is a pipe-shape member through whose interior the fuel gas passes, and the gas passage portion of the gas introduction portion is an opening portion that is provided in an end portion of the pipe-shape member.

16. The fuel cell according to claim 1, wherein the fuel cell is of an anode dead-end operation type, in which substantially an entire amount of the fuel gas supplied to the blocks is consumed on the anode.

17. The fuel cell according to claim 1, wherein an anode side of the fuel cell has a closed structure in which the fuel gas supplied to the anode is not discharged to outside.
